(19) United States
(12) Patent Application Publication
(10) Pub. No.: US 2026/0349827 A1
(43) Pub. Date: Nov. 5, 2026

(54) APPLICATION PROVISION DEVICE THAT PROVIDES APPLICATION, AND COMPUTER-READABLE, NON-TRANSITORY RECORDING MEDIUM HAVING APPLICATION PROVISION PROGRAM RECORDED THEREON

(71) Applicant: KYOCERA Document Solutions Inc., Osaka (JP)

(72) Inventor: Koki NAKAJIMA, Osaka (JP)

(73) Assignee: KYOCERA Document Solutions Inc., Osaka (JP)

(21) Appl. No.: 19/660,778

(22) Filed: Apr. 28, 2026

(30) Foreign Application Priority Data
Apr. 30, 2025 (JP) 2025-075505
Apr. 30, 2025 (JP) 2025-075506
Apr. 30, 2025 (JP) 2025-075507

(51) Int. Cl. G06F 9/50

(52) U.S. Cl. CPC G06F 9/505; G06F 2209/5022

(57) ABSTRACT

An application provision device includes a storage device and a control device. In the storage device, a tenant control program is stored. The control device includes a processor, and acts as a tenant controller when the processor executes the tenant control program. The tenant controller adjusts, when utilization status of a specific application by a specific tenant exceeds a predetermined utilization amount, a resource for the specific tenant to execute the specific application.

### INCORPORATION BY REFERENCE

This application claims priority to Japanese Patent Application No.2025-075505 filed on Apr. 30, 2025, Japanese Patent Application No. 2025-075506 filed on Apr. 30, 2025, and Japanese Patent Application No. 2025-075507 filed on Apr. 30, 2025, the entire contents of which are incorporated by reference herein.

### BACKGROUND

The present disclosure relates to an application provision device that provides an application, and a computer-readable, non-transitory recording medium having an application provision program recorded thereon.

A technique to perform provisioning of an execution resource, for each of tenants, when creating the tenant, is known.

### SUMMARY

The disclosure proposes further improvement of the foregoing techniques.

In an aspect, the disclosure provides an application provision device including a storage device and a control device. In the storage device, a tenant control program is stored. The control device includes a processor, and acts as a tenant controller when the processor executes the tenant control program. The tenant controller adjusts, when utilization status of a specific application by a specific tenant exceeds a predetermined utilization amount, a resource for the specific tenant to execute the specific application.

In another aspect, the disclosure provides a computer-readable, non-transitory recording medium having an application provision program recorded thereon. The application provision program causes a computer to act as a tenant controller that adjusts, when utilization status of a specific application by a specific tenant exceeds a predetermined utilization amount, a resource for the specific tenant to execute the specific application.

### BRIEF DESCRIPTION OF THE DRAWINGS

FIG. 1 is a block diagram showing an example of a system according to a first embodiment of the disclosure;

FIG. 2 is a block diagram showing an example of the API GW constituted of a single computer;

FIG. 3 is a block diagram showing an example of the cache system shown in FIG. 1, constituted of a single computer;

FIG. 4 is a table showing an example of the data shown in FIG. 3;

FIG. 5 is a table showing an example of the available application information shown in FIG. 4;

FIG. 6 is a table showing an example of the user-specific history information shown in FIG. 4;

FIG. 7 is a block diagram showing an example of the application provision device shown in FIG. 1, constituted of a single computer;

FIG. 8 is a table showing an example of the tenant management information shown in FIG. 7;

FIG. 9 is a table showing an example of the user management information shown in FIG. 7;

FIG. 10 is a table showing an example of the application utilization history information shown in FIG. 7;

FIG. 11 is a table showing an example of the threshold information shown in FIG. 7;

FIG. 12 is a block diagram showing an example of the client shown in FIG. 1, constituted of a PC;

FIG. 13 is a sequence chart showing an operation of the system shown in FIG. 1, performed when a user logs in to the application provision device via the client;

FIG. 14 is a schematic drawing showing an example of the log-in screen, displayed in the process shown in FIG. 13;

FIG. 15 is a sequence chart showing an operation of the system shown in FIG. 1, performed when an application provided by the application provision device is utilized by the client;

FIG. 16 is a schematic drawing showing an example of the application utilization screen, displayed in the process shown in FIG. 15;

FIG. 17 is a flowchart specifying the available application confirmation process shown in FIG. 15;

FIG. 18 is a flowchart showing an operation of the API GW shown in FIG. 2, performed to update the application utilization history information;

FIG. 19 is a flowchart showing an operation of the tenant controller shown in FIG. 7, performed upon receipt of a history update notice;

FIG. 20 is a flowchart showing an operation of the tenant controller shown in FIG. 7, performed when periodically confirming whether to perform provisioning of the execution resource for the application provision device;

FIG. 21 is a block diagram showing an example of the API GW constituted of a single computer, in a system according to a second embodiment;

FIG. 22 is a table showing an example of the communication restriction information;

FIG. 23 is a sequence chart showing an operation of the system according to the second embodiment, performed when an application provided by the application provision device is utilized by the client;

FIG. 24 is a flowchart showing an operation of the tenant controller according to the second embodiment, performed upon receipt of the history update notice;

FIG. 25 is a flowchart showing an operation of the tenant controller according to the second embodiment, performed when periodically confirming whether to perform provisioning of the execution resource for the application provision device;

FIG. 26 is a block diagram showing an example of a system according to a third embodiment of the disclosure;

FIG. 27 is a block diagram showing an example of the API GW constituted of a single computer, in the system according to the third embodiment;

FIG. 28 is a table showing an example of the communication restriction information;

FIG. 29 is a block diagram showing an example of the application provision device constituted of a single computer, in the system according to the third embodiment;

FIG. 30 is a table showing an example of the external resource expansion information;

FIG. 31 is a block diagram showing an example of the external hosting system constituted of a PC, in the system according to the third embodiment;

FIG. 32 is a flowchart showing an operation of the tenant controller according to the third embodiment, performed upon receipt of the history update notice; and

FIG. 33 is a flowchart showing an operation of the tenant controller, performed when periodically confirming whether to expand the execution resource of the application.

### DETAILED DESCRIPTION

Hereafter, an application provision device that provides an application, an application provision program, and a computer-readable, non-transitory recording medium having the application provision program recorded thereon, according to some embodiments of the disclosure, will be described with reference to the drawings.

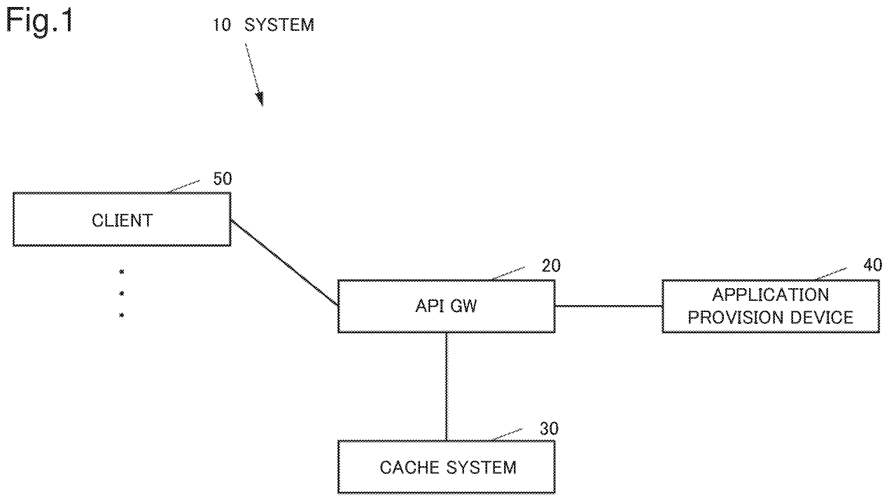

First, a configuration of a system according to a first embodiment of the disclosure will be described. FIG. 1 is a block diagram showing an example of a system 10, according to the first embodiment.

As shown in FIG. 1, the system 10 includes an application programming interface gateway (hereinafter, API GW) 20, acting as a token control system that executes control related to a token. The API GW 20 may be constituted of a single computer such as a personal computer (PC), or a plurality of computers. The API GW 20 may be provided on a cloud.

The system 10 includes a cache system 30 that retains the token. The cache system 30 may be constituted of a single computer such as a PC, or a plurality of computers. At least a part of the computers constituting the API GW 20 may also serve as at least a part of the computers constituting the cache system 30. The cache system 30 may be provided on a cloud.

The system 10 includes an application provision device 40 that provides applications. The applications provided by the application provision device 40 may be a Web application to be operated by a user, or a Web service that releases the API to be utilized by the Web application or the Web service. The application provision device 40 may be constituted of a single computer such as a PC, or a plurality of computers. At least a part of the computers constituting the API GW 20 may also serve as at least a part of the computers constituting the application provision device 40. At least a part of the computers constituting the cache system 30 may also serve as at least a part of the computers constituting the application provision device 40. The application provision device 40 may be provided on a cloud.

The system 10 includes a client 50, acting as a user terminal to be used by the user. The system 10 may include clients configured similarly to the client 50, in addition to the client 50. The client 50 is, for example, constituted of an information processing device such as a PC, a tablet, or a smartphone.

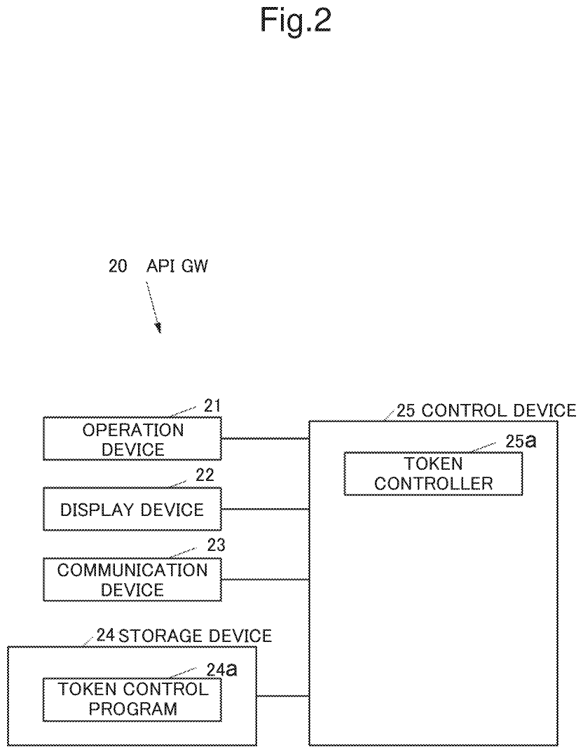

FIG. 2 is a block diagram showing a configuration of the API GW 20, constituted of a single computer.

As shown in FIG. 2, the API GW 20 includes an operation device 21 including, for example, a keyboard and a mouse for inputting various operations, a display device 22, for example including a liquid crystal display (LCD) for displaying various types of information, a communication device 23 that performs communication with an external device, via a network such as a local area network (LAN) or the internet, or directly through wired or wireless communication, a storage device 24 including a non-volatile memory unit such as a semiconductor memory or a hard disk drive (HDD), for storing various types of information, and a control device 25 that controls the overall operation of the API GW 20.

The storage device 24 includes an HDD or an SSD, and contains a token control program 24a for controlling the token. The token control program 24a may be, for example, installed in the API GW 20 during the manufacturing process thereof, additionally installed in the API GW 20 from an external storage medium such as a universal serial bus (USB) memory, or additionally installed in the API GW 20 from a network.

The control device 25 includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The control device 25 is provided with a token controller 25a. The processor exemplifies the computer. The processor of the control device 25 executes the programs stored in the storage device 24 or the ROM.

The control device 25 acts as the token controller 25a, when the processor operates according to the token control program 24a stored in the storage device 25. Here, the token controller 25a may be constituted in the form of a hardware circuit, instead of being realized by the operation of the control device 25 according to the token control program 24a. This also applies to other embodiments, unless otherwise specifically noted.

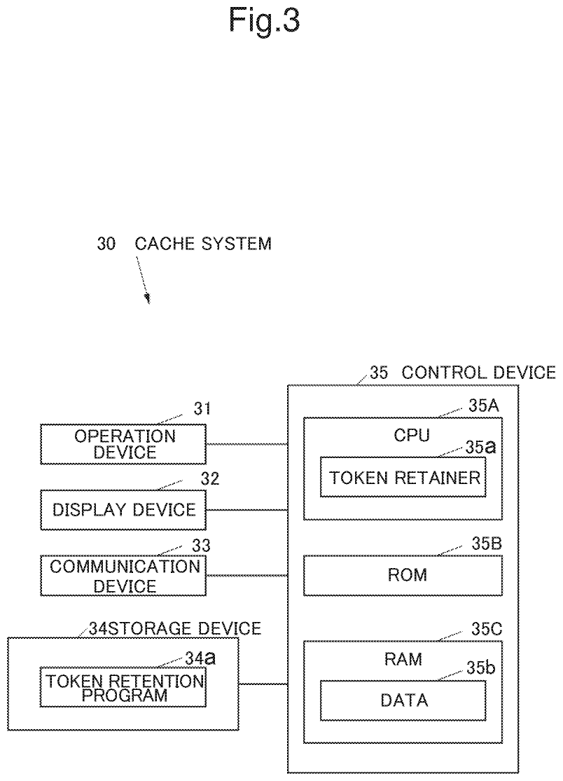

FIG. 3 is a block diagram showing the cache system 30, constituted of a single computer.

As shown in FIG. 3, the cache system 30 includes an operation device 31 including, for example, a keyboard and a mouse for inputting various operations, a display device 32, for example including an LCD for displaying various types of information, a communication device 33 that performs communication with an external device, via a network such as a LAN or the internet, or directly through wired or wireless communication, a storage device 34 including a non-volatile memory unit such as a semiconductor memory or an HDD, for storing various types of information, and a control device 35 including a control circuit that controls the overall operation of the cache system 30.

The storage device 34 contains a token retention program 34a for retaining the token. The token retention program 34a may be, for example, installed in the cache system 30 during the manufacturing process thereof, additionally installed in the cache system 30 from an external storage medium such as a USB memory, or additionally installed in the cache system 30 from the network.

The control device 35 includes, for example, a CPU 35A exemplifying the processor, a ROM 35B containing programs and various types of data, and a RAM 35C serving as the operation region for the CPU 35A of the control device 35. The CPU 35A of the control device 35 executes the programs stored in the storage device 34 or the ROM 35B.

The CPU 35A acts as a token retainer 35a, when the processor operates according to the token retention program 34a stored in the storage device 34.

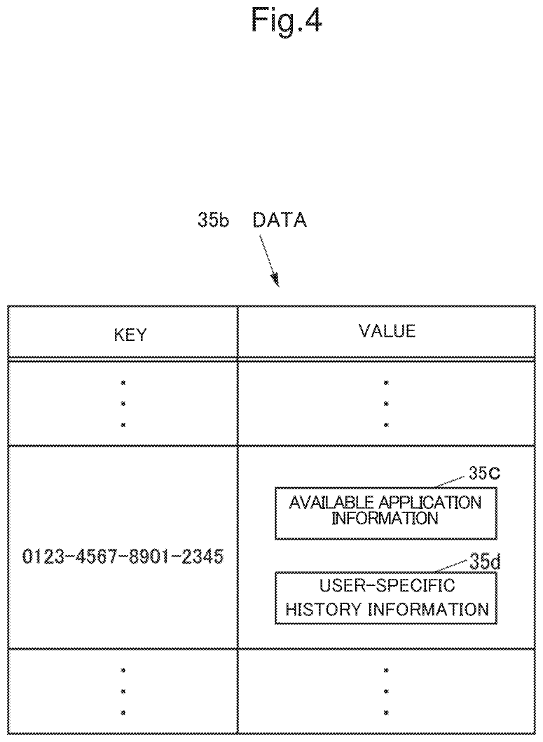

The RAM 35C stores therein data 35b of a key-value format, for managing the token. FIG. 4 is a table showing an example of the data 35b. As shown in FIG. 4, the data 35b includes the token as the key. The data 35b includes the information about the user to whom the token is applicable, as the value. Examples of the information about the user include the information related to the application available to the user (hereinafter, “available application information”) 35c, and the information indicating the utilization history of the application by the user (hereinafter, “user-specific history information”) 35d. The information about the user may be the information of a document format, such as JavaScript object notation (JSON) format, or extensible markup language (XML) format. The data 35b shown in FIG. 4 only shows a part of specific values.

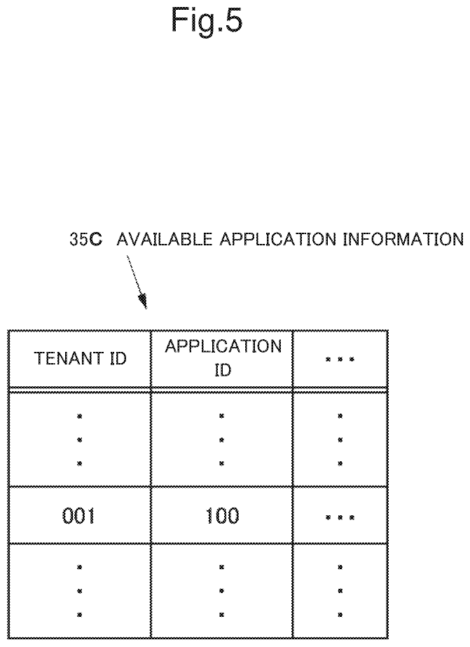

FIG. 5 is a table showing an example of the available application information 35c. As shown in FIG. 5, the available application information 35c includes a tenant ID of the tenant to which the user belongs, and an application ID serving as the identification information of the application available to the user. The available application information 35c shown in FIG. 5 only shows a part of specific values.

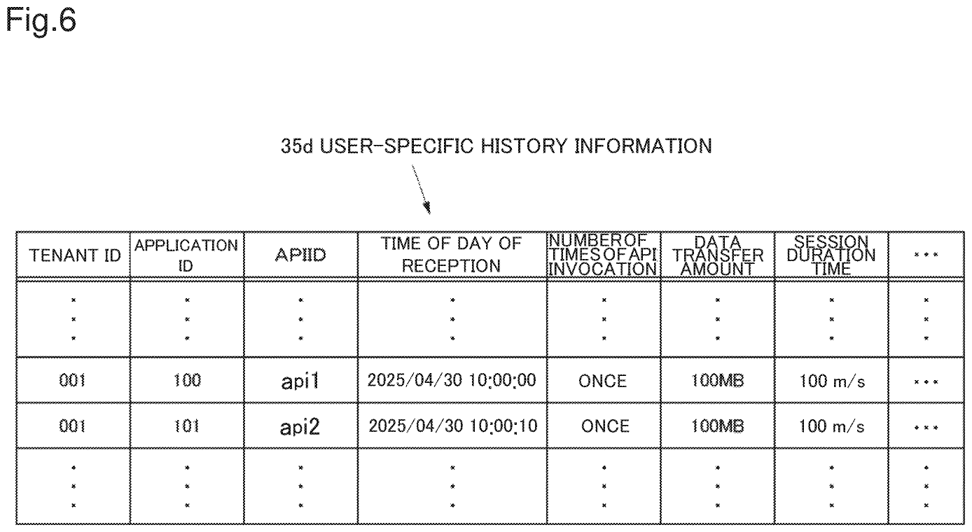

FIG. 6 is a table showing an example of the user-specific history information 35d. As shown in FIG. 6, the user-specific history information 35d includes the tenant ID, the application ID, an API ID serving as the identification information of the API, the time of the day that the API GW 20 received an application utilization instruction to be subsequently described (hereinafter, “time of day of reception”), the number of times that the API was invoked (hereinafter, “number of times of API invocation”), an amount of data transferred between the API GW 20 and the application (hereinafter, “data transfer amount”), and a duration time of the communication between the API GW 20 and the application, after the API GW 20 receives the application utilization instruction, and until the API GW 20 receives the response from the application, abbreviated as “session duration time”. The user-specific history information 35d shown in FIG. 6 only shows a part of specific values.

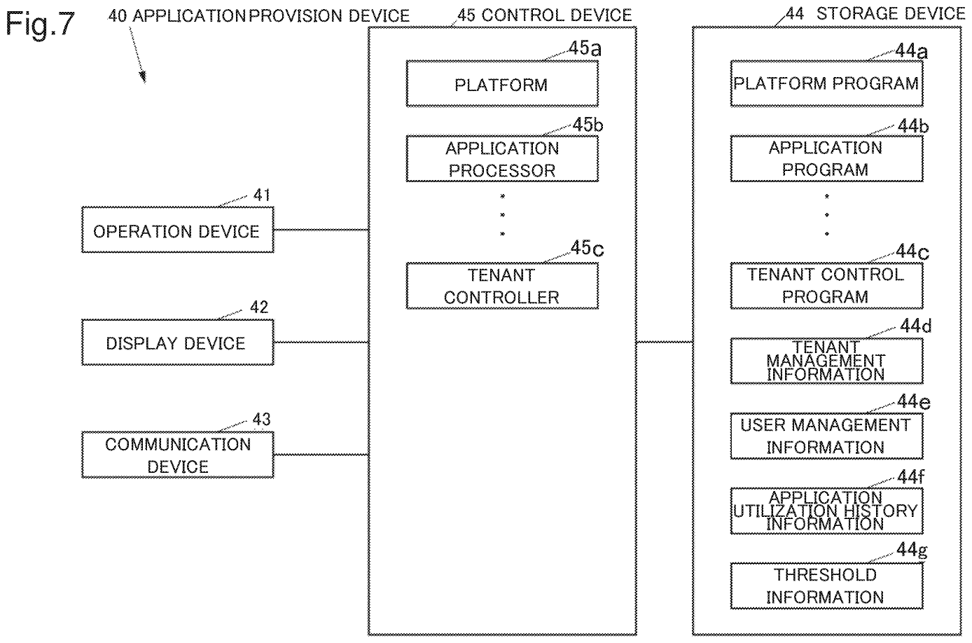

FIG. 7 is a block diagram showing a configuration of the application provision device 40, constituted of a single computer.

As shown in FIG. 7, the application provision device 40 includes an operation device 41 including, for example, a keyboard and a mouse for inputting various operations, a display device 42, for example including an LCD for displaying various types of information, a communication device 43 that performs communication with an external device, via a network such as a LAN or the internet, or directly through wired or wireless communication, a storage device 44 including a non-volatile memory unit such as a semiconductor memory or an HDD, for storing various types of information, and a control device 45 including a control circuit that controls the overall operation of the application provision device 40.

The storage device 44 stores therein a program for realizing the platform on which the application is executed (hereinafter, “platform program”) 44a. The platform program 44a may be, for example, installed in the application provision device 40 during the manufacturing process thereof, additionally installed in the application provision device 40 from an external storage medium such as a universal serial bus (USB) memory, or additionally installed in the application provision device 40 from a network.

The storage device 44 stores therein a plurality of programs for realizing the application (hereinafter, “application program”). For example, the storage device 44 stores therein an application program 44b. The application programs may be manufactured by a manufacturer different from that of the application provision device 40. The application program may be, for example, installed in the application provision device 40 during the manufacturing process thereof, additionally installed in the application provision device 40 from an external storage medium such as a universal serial bus (USB) memory, or additionally installed in the application provision device 40 from a network.

The storage device 44 stores therein a tenant control program 44c for controlling the tenants of the application provision device 40. The tenant control program 44c may be, for example, installed in the application provision device 40 during the manufacturing process thereof, additionally installed in the application provision device 40 from an external storage medium such as a universal serial bus (USB) memory, or additionally installed in the application provision device 40 from a network.

The storage device 44 stores therein a tenant management information 44d for managing the tenants of the application provision device 40.

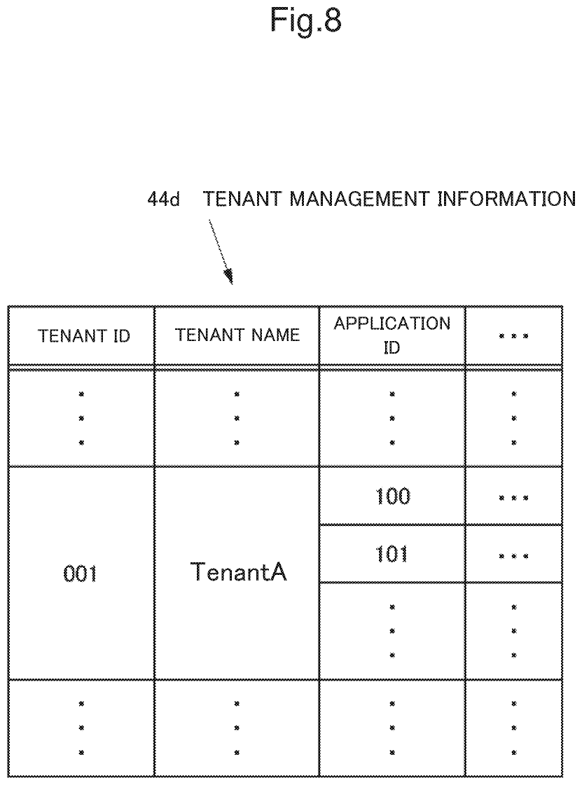

FIG. 8 is a table showing an example of the tenant management information 44d. As shown in FIG. 8, the tenant management information 44d includes the tenant ID serving as the identification information of the tenant, the tenant name representing the name of the tenant, and the application ID, with respect to each of the tenants. In the tenant management information 44d, a plurality of application IDs may be associated with each of the tenant IDs. The tenant management information 44d shown in FIG. 8 only shows a part of specific values.

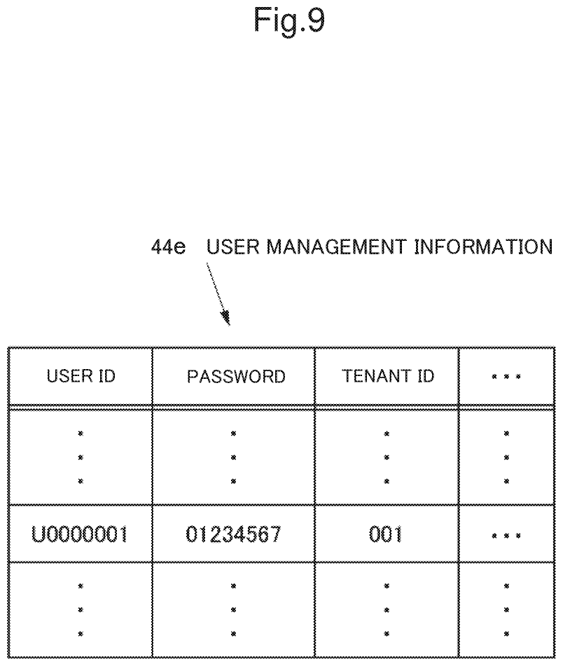

As shown in FIG. 7, the storage device 44 stores therein a user management information 44e for managing the users of the application provision device 40. FIG. 9 is a table showing an example of the user management information 44e. As shown in FIG. 9, the user management information 44e includes the user ID serving as the identification information of the user, the password of the user, and the tenant ID of the tenant to which the user belongs, with respect to each of the users. The user management information 44e shown in FIG. 9 only shows a part of specific values.

As shown in FIG. 7, the storage device 44 stores therein information indicating the utilization history of the application (hereinafter, “application utilization history information”) 44f.

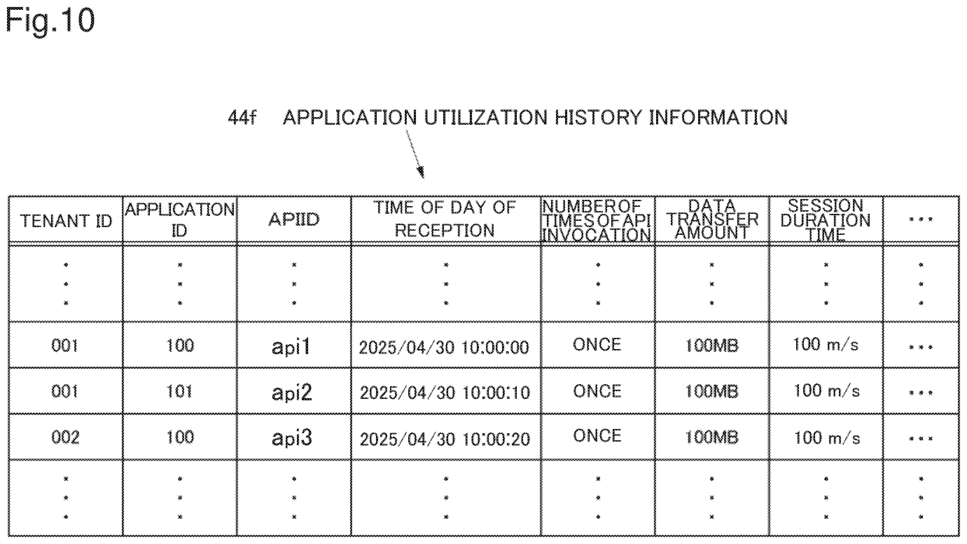

FIG. 10 is a table showing an example of the application utilization history information 44f. As shown in FIG. 10, the application utilization history information 44f includes the tenant ID, the application ID, the API ID, the time of day of reception, the number of times of API invocation, the data transfer amount, and the session duration time. The application utilization history information 44f shown in FIG. 10 only shows a part of specific values.

As shown in FIG. 7, the storage device 44 stores therein threshold information 44g, indicating a threshold for expanding the execution resource of the application provision device 40. Examples of the execution resource include the processing capacity of the server realizing the application provision device 40. The processing capacity of the server may be denoted, for example, by the transfer bandwidth of the network, and the storage capacity of a disk.

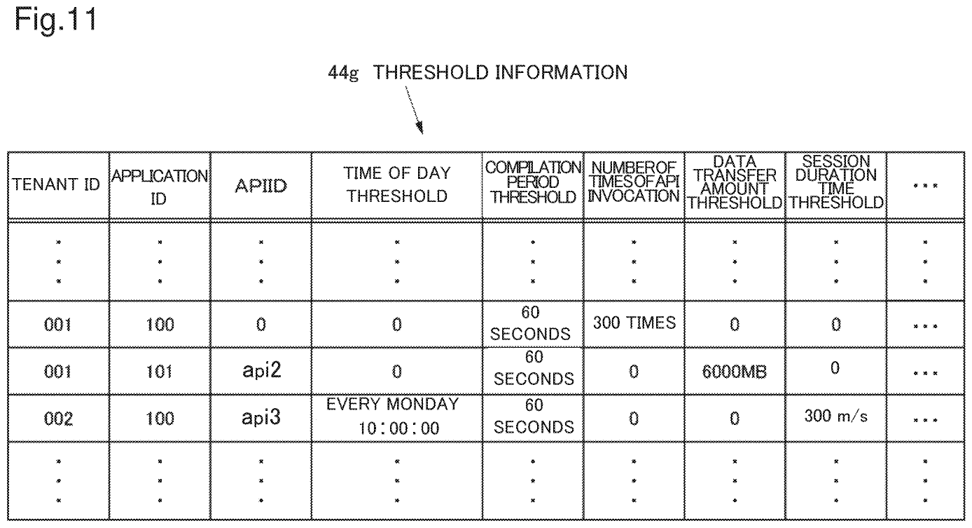

FIG. 11 is a table showing an example of the threshold information 44g. As shown in FIG. 11, the threshold information 44g includes the tenant ID of the tenant to which the threshold is applied, the application ID of the application to which the threshold is applied, the API ID of the API to which the threshold is applied, the time of the day specified as the threshold (hereinafter, “time of day threshold”), a period for compiling the data, specified as the threshold (hereinafter, “compilation period threshold”), the threshold of the number of times of API invocation, the threshold of the data transfer amount, and the threshold of the session duration time. The threshold information 44g shown in FIG. 11 only shows a part of specific values.

In FIG. 11, the value “0” of the API ID indicates that all the APIs are involved. The value “0” of the time of day threshold in FIG. 11 indicates that the threshold is applied at a timing according to an instruction from the API GW 20. The value “0” of the threshold in FIG. 11 indicates that the threshold of the corresponding item is not specified.

The values of the threshold information 44g may be, for example, specified by the provider of the application provision device 40. The value of a record of the threshold information 44g may be specified by the manager of the tenant relevant to the record.

The control device 45 shown in FIG. 7 includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The processor exemplifies the computer. The processor of the control device 45 executes the programs stored in the storage device 44 or the ROM of the control device 45.

The control device 45 acts as a platform 45a, when the processor operates according to the platform program 44a. The platform 45a releases the API utilized by the application.

The control device 45 acts as an application processor 45b, when the processor operates according to the application program.

In addition, the control device 45 acts as a tenant controller 45c that controls the tenant of the application provision device 40, when the processor operates according to the tenant control program 44c. The tenant controller 45c adjusts, when the utilization status of a specific application in a specific tenant exceeds a predetermined utilization amount (e.g., indicated by the threshold), the resource for executing the specific application, for the specific tenant. Examples of the adjustment of the resource include the provisioning of the resource, and expansion of the resource.

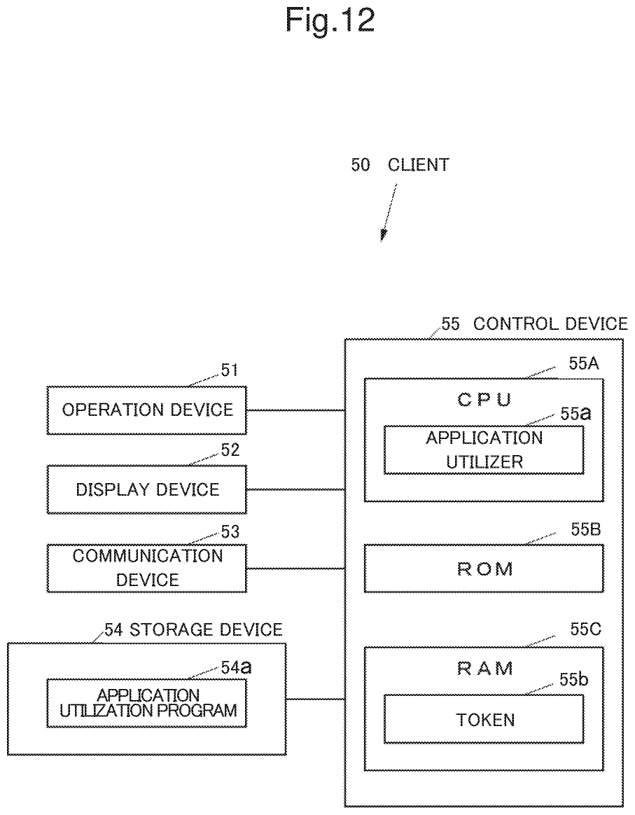

FIG. 12 is a block diagram showing a configuration of the client 50, constituted of a PC. As shown in FIG. 12, the client 50 includes an operation device 51 including, for example, a keyboard and a mouse for inputting various operations, a display device 52, for example including an LCD for displaying various types of information, a communication device 53 that performs communication with an external device, via a network such as a LAN or the internet, or directly through wired or wireless communication, a storage device 54 including a non-volatile memory unit such as a semiconductor memory or an HDD, for storing various types of information, and a control device 55 that controls the overall operation of the client 50.

The storage device 54 stores therein a program for utilizing the application (hereinafter, “application utilization program”) 54a. The application utilization program 54a may be, for example, installed in the client 50 during the manufacturing process thereof, additionally installed in the client 50 from an external storage medium such as a universal serial bus (USB) memory, or additionally installed in the client 50 from a network.

The controller 55 includes, for example, a CPU 55A exemplifying the processor, a ROM 55B containing programs and various types of data, and a RAM 55C serving as the operation region for the CPU 55A of the control device 55. The CPU 55A of the control device 55 executes the programs stored in the storage device 54 or the ROM 55B of the control device 55. The CPU 55A of the control device 55 acts as an application utilizer 55a, when the processor operates according to the application utilization program 54a stored in the storage device 54.

The ram 55c stores therein the token 55b.

Hereunder, an operation of the system 10 will be described. First, an operation of the system 10, performed when the user logs in to the application provision device 40, will be described. The following description represents the case where the user logs in to the application provision device 40 via the client 50.

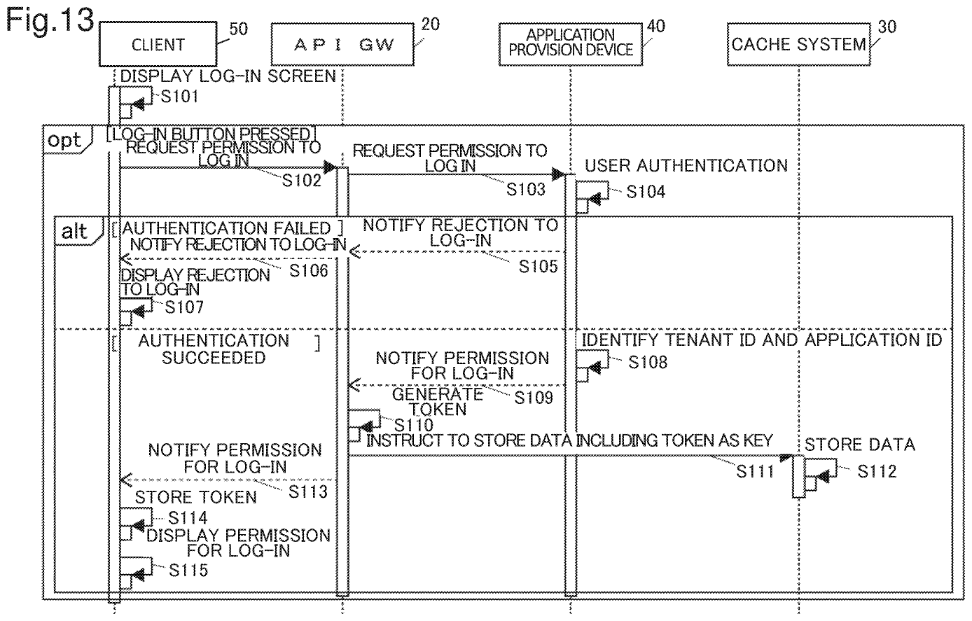

FIG. 13 is a sequence chart showing an operation of the system 10, performed when the user logs in to the application provision device 40 via the client 50.

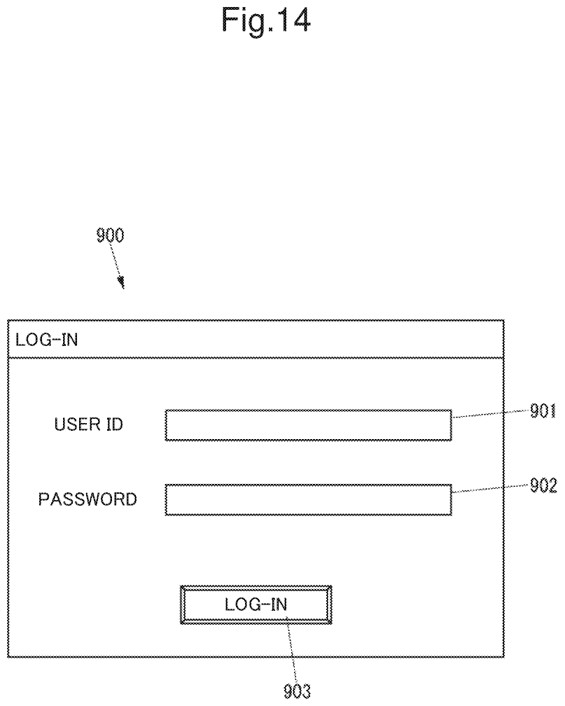

The user inputs an instruction to display a screen for logging in to the application provision device 40 (hereinafter, “log-in screen”), to the operation device 51 of the client 50. When the instruction to display the log-in screen is inputted to the operation device 51 of the client 50, the application utilizer 55a of the client 50 causes the display device 52 to display a log-in screen 900 (see FIG. 14) (S101).

FIG. 14 is a schematic drawing showing an example of the log-in screen 900. As shown in FIG. 14, the log-in screen 900 includes a textbox 901 which is a widget for displaying the user ID inputted to the operation device 51, a textbox 902 which is a widget for displaying the password inputted to the operation device 51, and a log-in button 903 for inputting the instruction to log in to the application provision device 40. The operation device 51 accepts the log-in instruction inputted through the log-in button 903, only when the value is inputted to both of the textbox 901 and the textbox 902.

After finishing the operation of S101, as shown in FIG. 13, when the instruction to log in is inputted to the operation device 51 through the log-in button 903 in the log-in screen 900, the application utilizer 55a of the client 50 requests the API GW 20 to permit the log-in, with the combination of the user ID inputted to the textbox 901 at the time that the log-in instruction was inputted, and the password inputted to the textbox 902 at the time that the log-in instruction was inputted (S102). The application utilizer 55a includes the combination of the user ID inputted to the textbox 901 at the time that the log-in instruction was inputted, and the password inputted to the textbox 902 at the time that the log-in instruction was inputted, in the request of S102.

Upon receipt of the request of S102, the token controller 25a of the API GW 20 requests the application provision device 40 to permit the log-in requested at S102 (S103). The token controller 25a includes the combination of the user ID and the password included in the request of S102, in the request of S103.

Upon receipt of the request of S102, the platform 45a of the application provision device 40 performs authentication of the user corresponding to the request of S103 (S104). To be more specific, when the combination of the user ID and the password included in the request of S103 is included in the user management information 44e, the platform 45a permits the user to log in. In contrast, when the combination of the user ID and the password included in the request of S103 is not included in the user management information 44e, the platform 45a does not permit the user to log in.

Upon deciding not to permit the user to log in, through the authentication performed at S104, the platform 45a notifies the API GW 20 that the log-in has been rejected (S105).

Upon receipt of the notice of S105, the token controller 25a of the API GW 20 notifies the client 50 that the log-in has been rejected (S106).

Upon receipt of the notice of S106, the application utilizer 55a of the client 50 causes the display device 52 to display a message indicating that the log-in has been rejected (S107).

Upon permitting the user to log in at S104, the platform 45a of the application provision device 40 identifies the tenant ID associated with the user ID used for the authentication of S104, in the user management information 44e, and all the application IDs associated with this tenant ID, in the tenant management information 44d (S108).

After finishing the operation of S108, the platform 45a notifies the API GW 20 that the log-in has been permitted (S109). At the same time, the platform 45a includes the tenant ID and the application ID identified at S108, in the notice of S109.

Upon receipt of the notice of S109, the token controller 25a of the API GW 20 generates the token (S110).

After finishing the operation of S110, the token controller 25a instructs the cache system 30 to store the data including the token generated at S110 as the key, and the available application information including the combination of the tenant ID and the application ID included in the notice of S109, as the value (S111).

Upon receipt of the instruction of S111, the token retainer 35a of the cache system 30 stores the data according to the instruction of S111, in the RAM 35C (S112).

After finishing the operation of S111, the token controller 25a of the API GW 20 notifies the client 50 that the log-in has been permitted (S113). The token controller 25a includes the token generated at S110, in the notice of S113.

Upon receipt of the notice of S113, the application utilizer 55a of the client 50 stores the token included in the notice of S113, in the RAM 55C as a token 55b (S114).

After finishing the operation of S114, the application utilizer 55a displays the permission to log in, on the display device 52 of the client 50 (S115).

In the process described above, the authentication of the user is performed at s104 by the platform 45a of the application provision device 40. Instead, the user authentication may be performed, for example, by an authentication provider with a communication protocol such as OAuth2.

Hereunder, an operation of the system 10, performed when the application provided by the application provision device 40 is utilized by the client, will be described.

The following description represents the operation performed by the system 10, when the application provided by the application provision device 40 is utilized by the client 50.

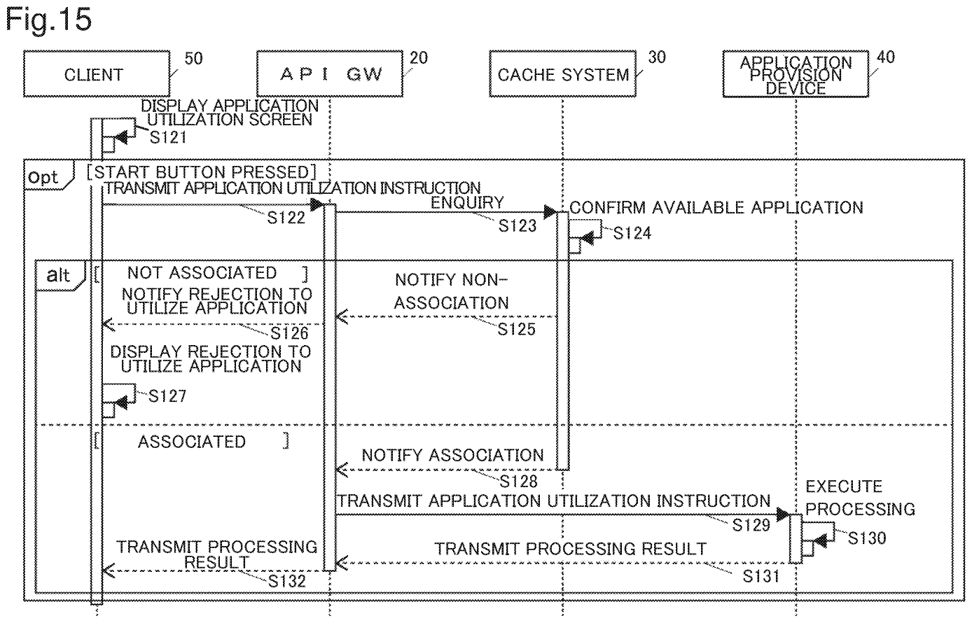

FIG. 15 is a sequence chart showing an operation of the system 10, performed when the application provided by the application provision device 40 is utilized by the client 50.

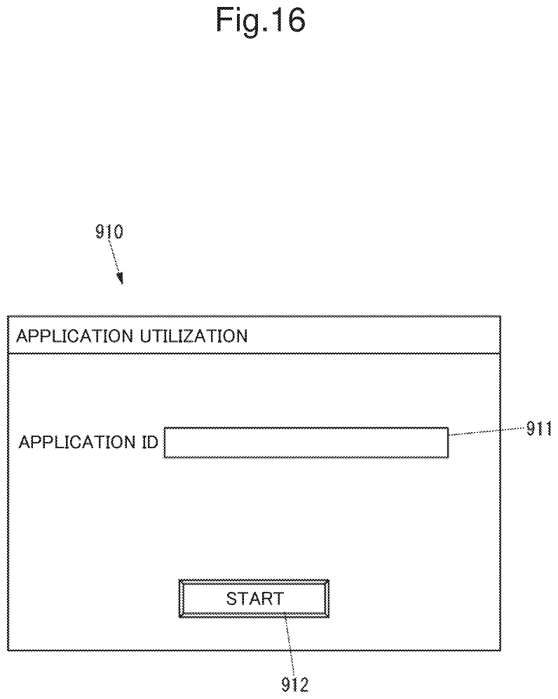

In the logged-in state to the application provision device 40 via the client 50, the user can instruct the client 50, via the operation device 51 thereof, to display a screen for utilizing the application provided by the application provision device 40 (hereinafter, “application utilization screen”). Upon receipt of the instruction to display the application utilization screen, the application utilizer 55a of the client 50 displays an application utilization screen 910 (see FIG. 16) on the display device 52 of the client 50, as shown in FIG. 15 (S121).

FIG. 16 is a schematic drawing showing an example of the application utilization screen 910.

The application utilization screen 910 shown in FIG. 16 includes a textbox 911 which is a widget for inputting the application ID of the application that the user wishes to utilize, and a start button 912 which is a widget for starting to utilize the application. The start button 912 can only be pressed, when a value is inputted to the textbox 911.

As shown in FIG. 15, when the start button 912 is pressed, the application utilizer 55a of the client 50 transmits an instruction to utilize the application (hereinafter, “application utilization instruction”) to the API GW 20 (S122). The application utilizer 55a includes the token 55b stored in the RAM 55C, and the application ID inputted to the textbox 911 at the time that the start button 912 was pressed, in the application utilization instruction.

Upon receipt of the application utilization instruction transmitted at S122, the token controller 25a of the API GW 20 enquires the cache system 30 whether the application ID included in the application utilization instruction is associated in the available application information, which is the value the key of which is the token included in the application utilization instruction (S123).

Upon receipt of the enquiry of S123, the token retainer 35a of the cache system 30 confirms whether the application ID enquired at S123 is associated (hereinafter, “available application confirmation process”).

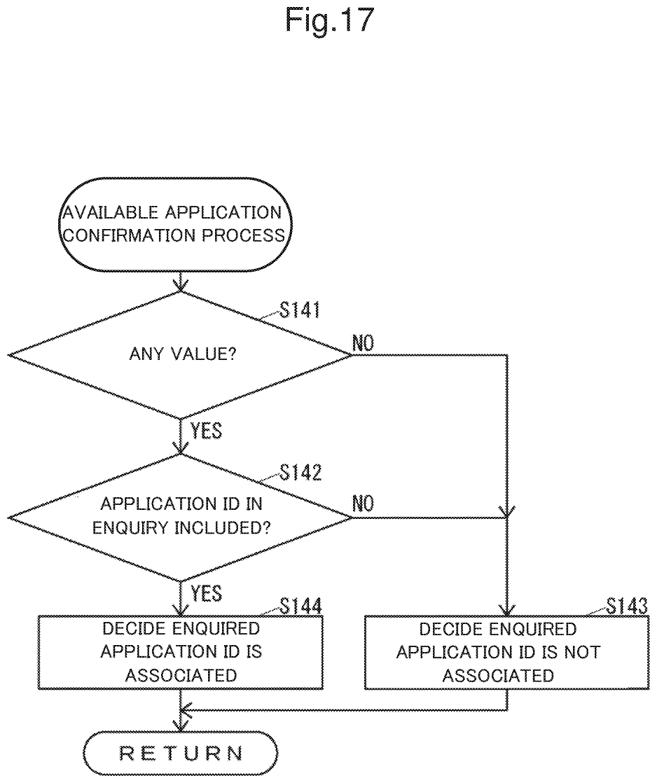

FIG. 17 is a flowchart specifying the available application confirmation process shown in FIG. 15. As shown in FIG. 17, the token retainer 35a decides whether there are any values, the key of which is the token included in the enquiry of S123 (S141).

Upon deciding at S141 that there are one or more values the key of which is the token included in the enquiry of S123, the token retainer 35a decides whether the available application information, which is the value the key of which is the token included in the enquiry of S123, includes the application ID included in the enquiry of S123 (S142).

Upon deciding at S141 that there is no value the key of which is the token included in the enquiry of S123, or deciding at S142 that the available application information, which is the value the key of which is the token included in the enquiry of S123, does not include the application ID included in the enquiry of S123, the token retainer 35a decides that the application ID enquired at S123 is not associated (S143).

Upon deciding at S142 that the available application information, which is the value the key of which is the token included in the enquiry of S123, includes the application ID included in the enquiry of S123, the token retainer 35a decides that the application ID enquired at S123 is associated (S144).

After finishing the operation of S143 or S144, the token retainer 35a finishes the available application confirmation process shown in FIG. 17.

As shown in FIG. 15, upon deciding through the available application confirmation process of S124, that the application ID enquired at S123 is not associated, the token retainer 35a notifies the API GW 20 that the application ID enquired at S123 is not associated (S125).

Upon receipt of the notice of S125, the token controller 25a of the API GW 20 notifies the client 50 that the utilization of the application has been rejected (S126).

Upon receipt of the notice of S126, application utilizer 55a of the client 50 displays a message indicating that the utilization of the application has been rejected, on the display device 52 (S127).

Upon deciding, through the available application confirmation process of S124, that the application ID enquired at S123 is associated, the token retainer 35a of the cache system 30 notifies the API GW 20 that the application ID enquired at S123 is associated (S128).

Upon receipt of the notice of S128, the token controller 25a of the API GW 20 transmits the application utilization instruction transmitted at S122, to the application processor 45b corresponding to the application utilization instruction (S129).

Upon receipt of the application utilization instruction transmitted at S129, the application processor 45b of the application provision device 40 executes the processing according to the application utilization instruction (S130).

After finishing the operation of S130, the application processor 45b transmits the result of the processing of S130, to the API GW 20 (S131).

Upon receipt of the processing result transmitted at S131, the token controller 25a of the API GW 20 transmits the processing result to the client 50 (S132).

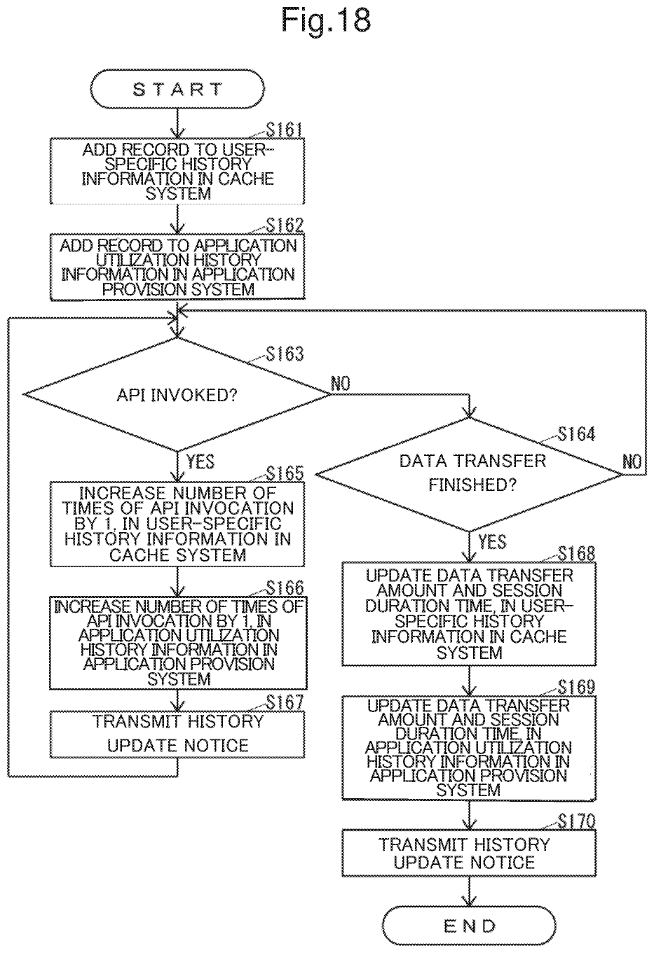

Hereunder, an operation of the API GW 20, performed to update the application utilization history information, will be described. FIG. 18 is a flowchart showing the operation of the API GW 20, performed to update the application utilization history information.

The token controller 25a of the API GW 20 performs the operation specified in FIG. 18, each time the application utilization instruction transmitted at S122 (hereinafter, “subject application utilization instruction” in the description regarding FIG. 18) is received.

As shown in FIG. 18, token controller 25a adds, to the user-specific history information which is the value the key of which is the token included in the subject application utilization instruction, among the data stored in the cache system 30, a record including the tenant ID indicated by the available application information of this value, the application ID included in the subject application utilization instruction, the API ID of the API which is the subject of the subject application utilization instruction, and the time of day that the subject application utilization instruction was received from the client, in other words the time of day of reception (S161).

After finishing the operation of S161, the token controller 25a adds a record, of the same content as the record added at S161, to the application utilization history information 44f of the application provision device 40 (S162).

After finishing the operation of S162, the token controller 25a decides whether the application has invoked the API according to the subject application utilization instruction (S163).

Upon deciding at S163 that the application has not invoked the API according to the subject application utilization instruction, the token controller 25a decides whether the data transfer between the API GW 20 and the application has finished, according to the subject application utilization instruction (S164).

Upon deciding at S164 that the data transfer between the API GW 20 and the application has not finished, according to the subject application utilization instruction, the token controller 25a executes the operation of S163.

Upon deciding at S163 that the application has invoked the API according to the subject application utilization instruction, the token controller 25a increases the number of times of API invocation by 1, in the record added at S161, among the data stored in the cache system 30. (S165).

After finishing the operation of S165, the token controller 25a increases the number of times of API invocation by 1, in the record added at S162, among the application utilization history information 44f of the application provision device 40 (S166).

After finishing the operation of S166, the token controller 25a transmits a notice that the application utilization history information 44f has been updated (hereinafter, “history update notice”) to the tenant controller 45c (S167). At the same time, the token controller 25a includes the information for identifying the record updated at S166, in the history update notice of S167. The information for identifying the record may be, for example, the combination of the tenant ID, the application ID, the API ID, and the time of day of reception, included in the record. The token controller 25a includes the number of times of API invocation in the history update notice of S167, as the item to be updated.

After finishing the operation of S167, the token controller 25a executes the operation of S163.

Upon deciding at S164 that the data transfer between the API GW 20 and the application has finished, according to the subject application utilization instruction, the token controller 25a updates the data transfer amount and the session duration time, in the record added at S161, among the data stored in the cache system 30 (S168). In other words, the token controller 25a writes the amount of data transferred between the API GW 20 and the application, according to the subject application utilization instruction, in the record added at S161, among the data stored in the cache system 30. Likewise, the token controller 25a writes the session duration time according to the subject application utilization instruction, in the record added at S161, among the data stored in the cache system 30.

After finishing the operation of S168, the token controller 25a updates the data transfer amount and the session duration time, in the record added at S162, among the application utilization history information 44f of the application provision device 40 (S169). In other words, the token controller 25a writes the amount of data transferred between the API GW 20 and the application, according to the subject application utilization instruction, in the record added at S162, among the application utilization history information 44f of the application provision device 40. Likewise, the token controller 25a writes the session duration time according to the subject application utilization instruction, in the record added at S162, among the application utilization history information 44f of the application provision device 40.

After finishing the operation of S169, the token controller 25a transmits the history update notice to the tenant controller 45c (S170). At the same time, the token controller 25a includes the information for identifying the record updated at S169, in the history update notice of S170. The information for identifying the record may be, for example, the combination of the tenant ID, the application ID, the API ID, and the time of day of reception included in the record. The token controller 25a includes the data transfer amount and the session duration time, in the history update notice of S170, as the item to be updated.

After finishing the operation of S170, the token controller 25a finishes the operation specified in FIG. 18.

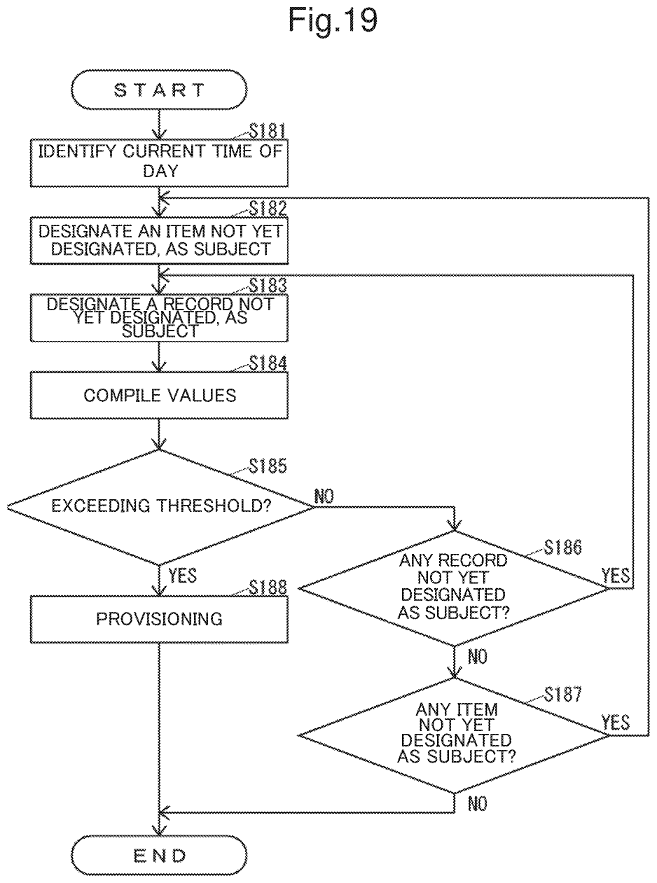

Hereunder, an operation of the tenant controller 45c, performed upon receipt of the history update notice, will be described. FIG. 19 is a flowchart showing the operation of the tenant controller 45c, performed upon receipt of the history update notice.

Upon receipt of the history update notice (hereinafter, “subject history update notice” in the description regarding FIG. 19), the tenant controller 45c executes the operation specified in FIG. 19.

As shown in FIG. 19, the tenant controller 45c identifies the current time of the day (S181).

After finishing the operation of S181, the tenant controller 45c designates an item, not yet designated as the subject in the current operation according to FIG. 19, among the items to be updated included in the subject history update notice, as the subject (S182).

After finishing the operation of S182, the tenant controller 45c designates, as the subject, a record not yet designated as the subject in the current operation according to FIG. 19, among the records in the threshold information 44g, including the tenant ID, the application ID, and the API ID included in the subject history update notice, and in which the time of day threshold is set as “0”, and the threshold for the item which is the current subject is specified (S183).

After finishing the operation of S183, the tenant controller 45c compiles the values of the items which are the current subject, with respect to the history that satisfies the condition of the tenant ID, the application ID, and the API ID in the record which is the current subject in the threshold information 44g, and that includes the time of day of reception, in the period preceding from the time of day identified at S181, the time of day identified at S181 inclusive, by the period corresponding to the compilation period threshold in the record which is the current subject, among the histories included in the application utilization history information 44f (S184).

After finishing the operation of S184, the tenant controller 45c decides whether the compiled value of S184 is higher than the threshold of the item which is the current subject, in the record which is the current subject in the threshold information 44g (S185).

Upon deciding at S185 that the compiled value of S184 is not higher than the threshold of the item which is the current subject, in the record which is the current subject in the threshold information 44g, the tenant controller 45c decides whether there are one or more records not yet designated as the subject in the current operation according to FIG. 19, among the records in the threshold information 44g, including the tenant ID, the application ID, and the API ID included in the subject history update notice, and in which the time of day threshold is set as “0”, and the threshold for the item which is the current subject is specified (S186).

Upon deciding at S186 that there are one or more records not yet designated as the subject in the current operation according to FIG. 19, among the records in the threshold information 44g, including the tenant ID, the application ID, and the API ID included in the subject history update notice, and in which the time of day threshold is set as “0”, and the threshold for the item which is the current subject is specified, the tenant controller 45c executes the operation of S183.

Upon deciding at S186 that there is no record not yet designated as the subject in the current operation according to FIG. 19, among the records in the threshold information 44g, including the tenant ID, the application ID, and the API ID included in the subject history update notice, and in which the time of day threshold is set as “0”, and the threshold for the item which is the current subject is specified, the tenant controller 45c decides whether there is an item not yet designated as the subject in the current operation according to FIG. 19, among the items to be updated included in the subject history update notice (S187).

Upon deciding at S187 that there are one or more items not yet designated as the subject in the current operation according to FIG. 19, among the items to be updated included in the subject history update notice, the tenant controller 45c executes the operation of S182.

Upon deciding at S185 that the compiled value of S184 is higher than the threshold of the item which is the current subject, in the record which is the current subject in the threshold information 44g, the tenant controller 45c performs the provisioning of the resource for executing the application, identified on the basis of the combination of the tenant ID and the application ID included in the subject history update notice, among the applications in the application provision device 40 (S188).

Upon deciding at S187 that there is no item that has not been designated as the subject in the current operation according to FIG. 19, among the items to be updated included in the subject history update notice, or finishing the operation of S188, the tenant controller 45c finishes the operation specified in FIG. 19.

Hereunder, an operation of the tenant controller 45c, performed when periodically confirming whether to perform the provisioning of the execution resource for the application provision device 40, will be described.

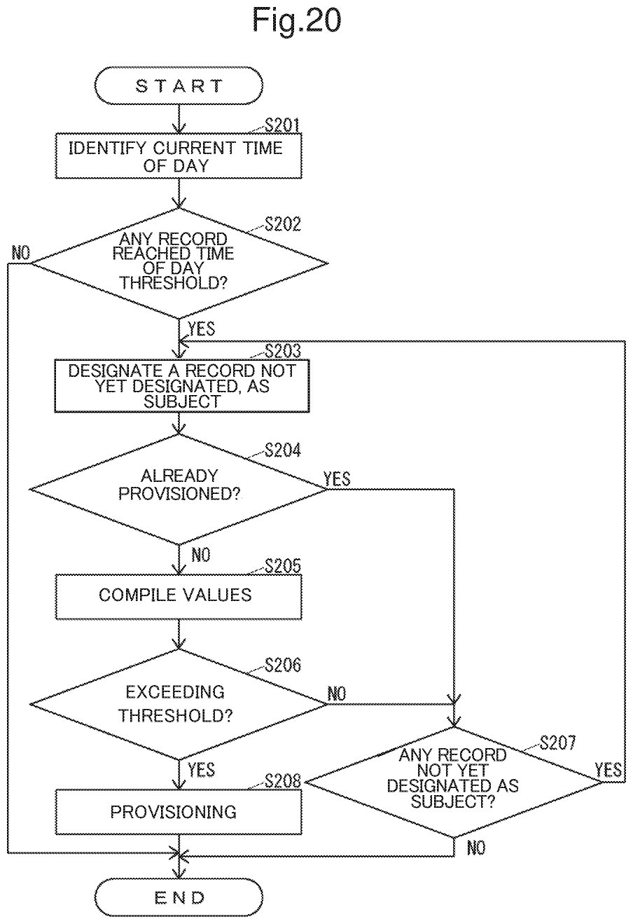

FIG. 20 is a flowchart showing an operation of the tenant controller 45c, performed when periodically confirming whether to perform provisioning of the execution resource for the application provision device 40.

The tenant controller 45c executes the operation specified in FIG. 20 periodically, for example every minute.

As shown in FIG. 20, the tenant controller 45c identifies the current time of the day (S201).

After finishing the operation of S201, the tenant controller 45c decides whether there are one or more records that reached the time of day threshold, after the time of day identified at S201 in the previous operation according to FIG. 20, and before the time of day identified at S201 in the current operation according to FIG. 20, among the records included in the threshold information 44g (S202).

Upon deciding at S202 that there are one or more records that reached the time of day threshold, after the time of day identified at S201 in the previous operation according to FIG. 20, and before the time of day identified at S201 in the current operation according to FIG. 20, among the records included in the threshold information 44g, the tenant controller 45c designates, as the subject, a record not yet designated as the subject in the current operation according to FIG. 20, among the records included in the threshold information 44g that reached the time of day threshold, after the time of day identified at S201 in the previous operation according to FIG. 20, and before the time of day identified at S201 in the current operation according to FIG. 20 (S203).

After finishing the operation of S203, the tenant controller 45c decides whether the resource for executing the application, identified by the combination of the tenant ID and the application ID in the record which is the current subject in the threshold information 44g, has already been provisioned in the current operation according to FIG. 20 (S204).

Upon deciding at S204 that the resource for executing the application, identified by the combination of the tenant ID and the application ID in the record which is the current subject in the threshold information 44g, has not yet been provisioned in the current operation according to FIG. 20, the tenant controller 45c compiles the values of the items for which the threshold is specified, in the record which is the current subject in the threshold information 44g, with respect to the history that satisfies the condition of the tenant ID, the application ID, and the API ID in the record which is the current subject in the threshold information 44g, and that includes the time of day of reception, in the period preceding from the time of day identified at S201, the time of day identified at S201 inclusive, by the period corresponding to the compilation period threshold in the record which is the current subject, among the histories included in the application utilization history information 44f (S205).

After finishing the operation of S205, the tenant controller 45c decides whether the compiled value of S205 is higher than the threshold specified for the record which is the current subject, in the threshold information 44g (S206).

Upon deciding at S204 that the resource for executing the application, identified by the combination of the tenant ID and the application ID in the record which is the current subject in the threshold information 44g, has already been provisioned in the current operation according to FIG. 20, or deciding at S206 that the compiled value of S205 is not higher than the threshold specified in the record which is the current subject, in the threshold information 44g, the tenant controller 45c decides whether there are one or more records not yet designated as the subject in the current operation according to FIG. 20, among the records in the threshold information 44g that reached the time of day threshold after the time of day identified at S201 in the previous operation according to FIG. 20, and before the time of day identified at S201 in the current operation according to FIG. 20 (S207).

Upon deciding at S207 that there are one or more records not yet designated as the subject in the current operation according to FIG. 20, among the records in the threshold information 44g that reached the time of day threshold after the time of day identified at S201 in the previous operation according to FIG. 20, and before the time of day identified at S201 in the current operation according to FIG. 20, the tenant controller 45c executes the operation of S203.

Upon deciding at S206 that the compiled value of S205 is higher than the threshold specified for the record which is the current subject, in the threshold information 44g, the tenant controller 45c performs the provisioning of the resource for executing the application, identified on the basis of the combination of the tenant ID and the application ID included in the record which is the current subject in the threshold information 44g, among the applications in the application provision device 40 (S208).

Upon deciding at S202 that there is no record that reached the time of day threshold, after the time of day identified in the previous operation according to FIG. 20, and before the time of day identified in the current operation according to FIG. 20, among the records included in the threshold information 44g, deciding at S207 that there is no record not yet designated as the subject in the current operation according to FIG. 20, among the records in the threshold information 44g that reached the time of day threshold after the time of day identified at S201 in the previous operation according to FIG. 20, and before the time of day identified at S201 in the current operation according to FIG. 20, or finishing the operation of S208, the tenant controller 45c finishes the operation specified in FIG. 20.

According to the foregoing description, the API GW 20 updates the user-specific history information of the cache system 30, and the application utilization history information 44f of the application provision device 40 (S161, S162, S165, S166, S168, and S169). Instead, when the API GW 20 updates the user-specific history information of the cache system 30, the platform 45a of the application provision device 40 may update the application utilization history information 44f of the application provision device 40, in synchronization with the user-specific history information of the cache system 30. When the platform 45a updates the application utilization history information 44f of the application provision device 40, the platform 45a may transmit the history update notice to the tenant controller 45c.

As described above, when the utilization status of a specific application by a specific tenant exceeds a predetermined utilization amount (YES at S185 or S206), the application provision device 40 performs the provisioning of the resource for this tenant to execute the application (S188 or S208). Therefore, the execution resource can be provisioned, according to the utilization status of the application.

When the number of times of API invocation by a specific application exceeds a predetermined utilization amount (S166, and YES at S185 or S206), the application provision device 40 performs the provisioning of the resource for a specific tenant to execute the specific application (S188 or S208). Therefore, the execution resource can be provisioned, according to the number of times of API invocation by a specific application.

When the data transfer amount between the API GW 20 and a specific application exceeds a predetermined utilization amount (S169, and YES at S185 or S206), the application provision device 40 performs the provisioning of the resource for a specific tenant to execute the specific application (S188 or S208). Therefore, the execution resource can be provisioned, according to the data transfer amount between the API GW 20 and a specific application.

When the session duration time between the API GW 20 and a specific application exceeds a predetermined utilization amount (S169, and YES at S185 or S206), the application provision device 40 performs the provisioning of the resource for a specific tenant to execute the specific application (S188 or S208). Therefore, the execution resource can be provisioned, according to the session duration time between the API GW 20 and a specific application.

The application provision device 40 decides whether the utilization status exceeds the predetermined utilization amount, each time the utilization status changes (S185). Therefore, the execution resource can be immediately provisioned, according to the utilization status of the application.

The application provision device 40 periodically checks whether the utilization status exceeds the predetermined utilization amount (S206). Therefore, the execution resource can be periodically provisioned, according to the utilization status of the application.

Hereunder, the system 10 according to a second embodiment of the disclosure will be described. Regarding the second embodiment, the description of the elements or operations similar to those of the first embodiment will not be repeated. In other words, the configuration and operation of the API GW 20, the cache system 30, the application provision device 40, and the client 50 of the system 10 according to the second embodiment are similar to those of the first embodiment, unless otherwise specifically noted.

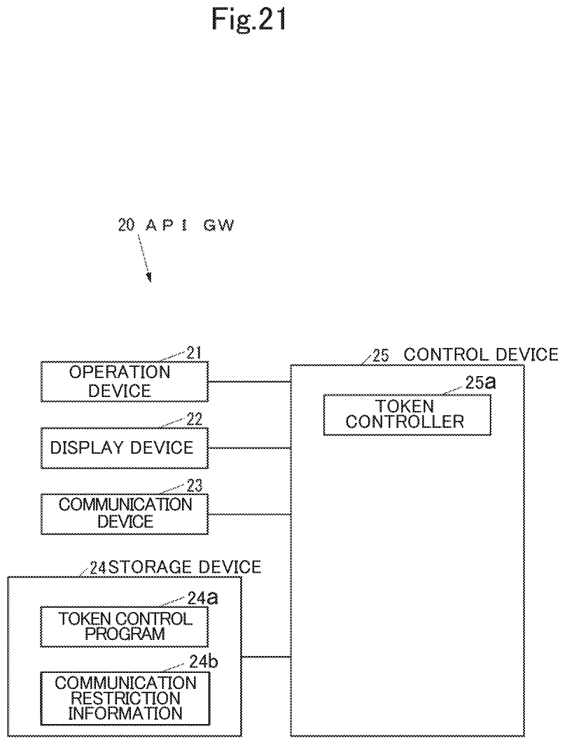

FIG. 21 is a block diagram showing an example of the API GW 20 constituted of a single computer, in the system 10 according to the second embodiment.

As shown in FIG. 21, the storage device 24 of the API GW 20 according to the second embodiment further stores therein information for restricting communication with the application (hereinafter, “communication restriction information”) 24b, in addition to the token control program 24a.

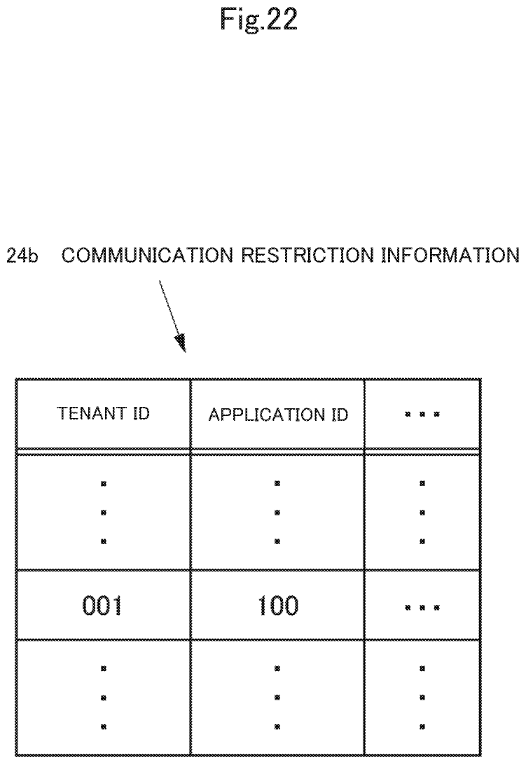

FIG. 22 is a table showing an example of the communication restriction information 24b. As shown in FIG. 22, the communication restriction information 24b includes the tenant ID serving as the identification information of the tenant, and the application ID serving as the identification information of the application, with respect to each of the applications. The communication restriction information 24b shown in FIG. 22 only shows a part of specific values.

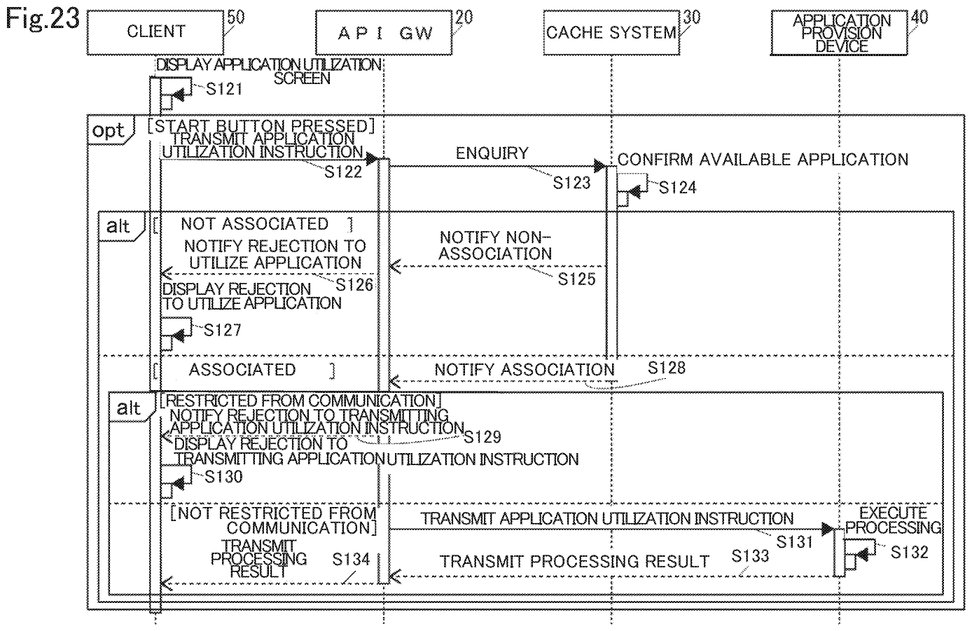

Hereunder, an operation of the system 10 according to the second embodiment, performed when the application provided by the application provision device 40 is utilized by the client 50, will be described. FIG. 23 is a sequence chart showing the operation of the system 10 according to the second embodiment, performed when the application provided by the application provision device 40 is utilized by the client 50.

In the second embodiment also, when the client 50 utilizes the application provided by the application provision device 40, the token retainer 35a of the cache system 30 notifies the API GW 20 that the application ID enquired at S123 is associated, when deciding, through the available application confirmation process of S124, that the application ID enquired at S123 is associated, like in the first embodiment (S128).

At this point, in the second embodiment, when the application identified by the tenant ID, indicated by the available application information, which is the value the key of which is the token included in the application utilization instruction in the data stored in the cache system 30, and the application ID included in the application utilization instruction, is the subject of the communication restriction, the token controller 25a of the API GW 20 notifies the client 50, upon receipt of the notice of S128, that the application utilization instruction is unable to be transmitted to the application (S129). Here, the token controller 25a decides that the application identified by the tenant ID, indicated by the available application information, which is the value the key of which is the token included in the application utilization instruction in the data stored in the cache system 30, and the application ID included in the application utilization instruction, is the subject of the communication restriction, when the combination of the tenant ID, indicated by the available application information, which is the value the key of which is the token included in the application utilization instruction in the data stored in the cache system 30, and the application ID included in the application utilization instruction, is included in the communication restriction information 24b.

Upon receipt of the notice of S129, the application utilizer 55a of the client 50 displays a message to the effect that the application utilization instruction is unable to be transmitted to the application, on the display device 52 (S130).

When the application identified by the tenant ID, indicated by the available application information, which is the value the key of which is the token included in the application utilization instruction in the data stored in the cache system 30, and the application ID included in the application utilization instruction, is not the subject of the communication restriction, the token controller 25a of the API GW 20 transmits, upon receipt of the notice of S128, the application utilization instruction transmitted at S122, to the application indicated by the application utilization instruction (S131). Here, the token controller 25a decides that the application identified by the tenant ID, indicated by the available application information, which is the value the key of which is the token included in the application utilization instruction in the data stored in the cache system 30, and the application ID included in the application utilization instruction, is not the subject of the communication restriction, when the combination of the tenant ID, indicated by the available application information, which is the value the key of which is the token included in the application utilization instruction in the data stored in the cache system 30, and the application ID included in the application utilization instruction, is not included in the communication restriction information 24b.

Upon receipt of the application utilization instruction transmitted at S131, the application of the application provision device 40 executes the operation according to the application utilization instruction (S132).

Upon finishing the operation of S132, the application notifies the processing result of S132, to the API GW 20 (S133).

Upon receipt of the processing result transmitted at S133, the token controller 25a of the API GW 20 transmits the processing result to the client 50 (S134).

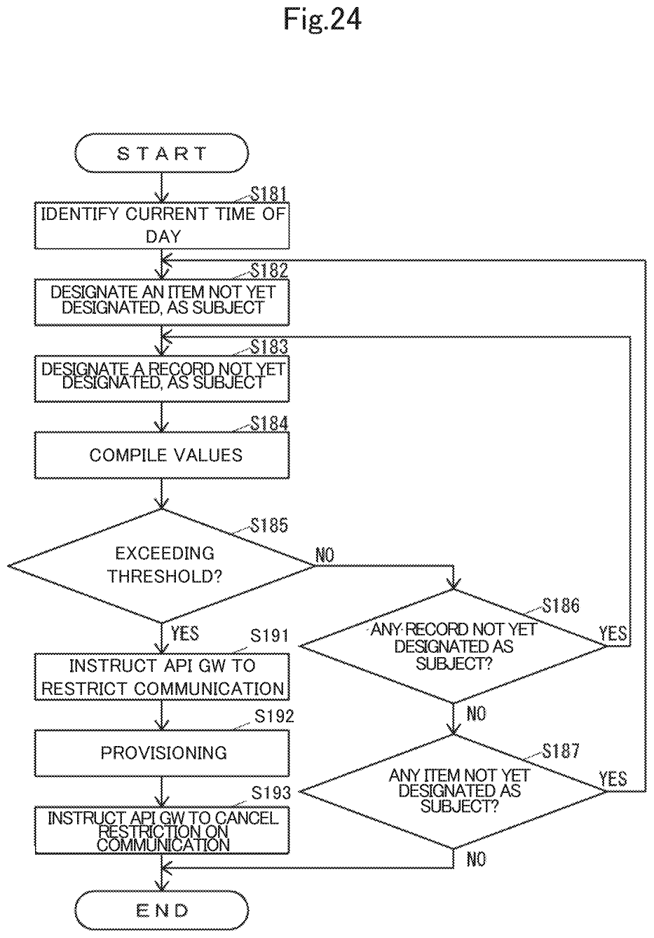

Hereunder, an operation of the tenant controller 45c according to the second embodiment, performed upon receipt of the history update notice, will be described. FIG. 24 is a flowchart showing the operation of the tenant controller 45c according to the second embodiment, performed upon receipt of the history update notice.

In the second embodiment, the tenant controller 45c instructs the API GW 20, upon deciding at S185 that the compiled value of S184 is higher than the threshold of the item which is the current subject, in the record which is the current subject in the threshold information 44g, to restrict the communication with the application, identified by the combination of the tenant ID and the application ID included in the subject history update notice (S191). Upon receipt of the instruction of S191, the token controller 25a of the API GW 20 writes the combination of the tenant ID and the application ID included in the instruction of S191, in the communication restriction information 24b.

After finishing the operation of S191, the tenant controller 45c performs the provisioning of the resource for executing the application in the application provision device 40, identified by the combination of the tenant ID and the application ID included in the subject history update notice (S192).

After finishing the operation of S189, the tenant controller 45c instructs the API GW 20 to cancel the restriction on the communication, with the application identified by the combination of the tenant ID and the application ID included in the subject history update notice (S193). Upon receipt of the instruction of S193, the token controller 25a of the API GW 20 deletes the combination of the tenant ID and the application ID included in the instruction of S193, from the communication restriction information 24b.

Upon deciding at S187 that there is no item not yet designated as the subject in the current operation according to FIG. 20, among the items to be updated included in the subject history update notice, or finishing the operation of S193, the tenant controller 45c finishes the operation specified in FIG. 24.

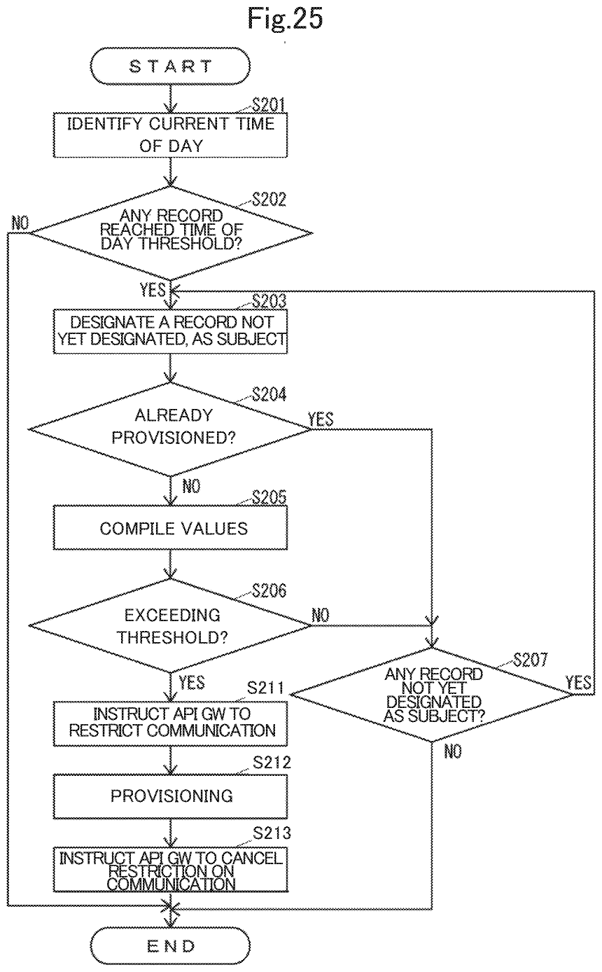

Hereunder, an operation of the tenant controller 45c according to the second embodiment, performed when periodically confirming whether to perform the provisioning of the execution resource for the application provision device 40, will be described. FIG. 25 is a flowchart showing the operation of the tenant controller 45c according to the second embodiment, performed when periodically confirming whether to perform the provisioning of the execution resource for the application provision device 40.

In the second embodiment, the tenant controller 45c instructs the API GW 20 to restrict the communication with the application identified by the combination of the tenant ID and the application ID, in the record which is the current subject in the threshold information 44g, upon deciding at S206 that the compiled value of S205 exceeds the threshold specified for the record which is the current subject in the threshold information 44g (S211). Upon receipt of the instruction of S211, the token controller 25a of the API GW 20 writes the combination of the tenant ID and the application ID included in the instruction of S211, in the communication restriction information 24b.

After finishing the operation of S208, the tenant controller 45c performs the provisioning of the resource for executing the application in the application provision device 40, identified by the combination of the tenant ID and the application ID in the record which is the current subject in the threshold information 44g (S212).

After finishing the operation of S212, the tenant controller 45c instructs the API GW 20 to cancel the restriction on the communication with the application identified by the combination of the tenant ID and the application ID, in the record which is the current subject in the threshold information 44g (S213). Upon receipt of the instruction of S213, the token controller 25a of the API GW 20 deletes the combination of the tenant ID and the application ID included in the instruction of S213, from the communication restriction information 24b.

Upon deciding at S202 that there is no record that reached the time of day threshold, after the time of day identified at S201 in the previous operation according to FIG. 25, and before the time of day identified at S201 in the current operation, among the records included in the threshold information 44g, deciding at S207 that there is no record not yet designated as the subject in the current operation, among the records in the threshold information 44g that reached the time of day threshold, after the time of day identified at S201 in the previous operation, and before the time of day identified at S201 in the current operation, or finishing the operation of S213, the tenant controller 45c finishes the operation specified in FIG. 25.

As described above, when the utilization status of a specific application by a specific tenant exceeds a predetermined utilization amount (YES at S185 or S206), the application provision device 40 according to the second embodiment performs the provisioning of the resource for this tenant to execute the application (S188 or S208). Therefore, the execution resource can be provisioned, according to the utilization status of the application.

The application provision device 40 according to the second embodiment performs the provisioning, after restricting a specific tenant from communicating with a specific application at S191 or S211, of the resource for this tenant to execute the application (S192 or S212). Such an arrangement reduces the likelihood that a malfunction occurs, owing to execution of communication by the specific tenant with the specific application, while the resource for this tenant to execute the application is being provisioned.

The application provision device 40 according to the second embodiment cancels the restriction on the communication by the specific tenant with the specific application (S193 or S213), after performing the provisioning of the resource for this tenant to execute the application at S192 or S212, with the communication by this tenant with the application being restricted at S191 or S211. Therefore, the convenience in use can be improved.

Hereunder, the system 10 according to a third embodiment of the disclosure will be described. Regarding the third embodiment, the description of the elements or operations similar to those of the first embodiment will not be repeated. In other words, the configuration and operation of the API GW 20, the cache system 30, the application provision device 40, and the client 50 of the system 10 according to the third embodiment are similar to those of the first embodiment, unless otherwise specifically noted.

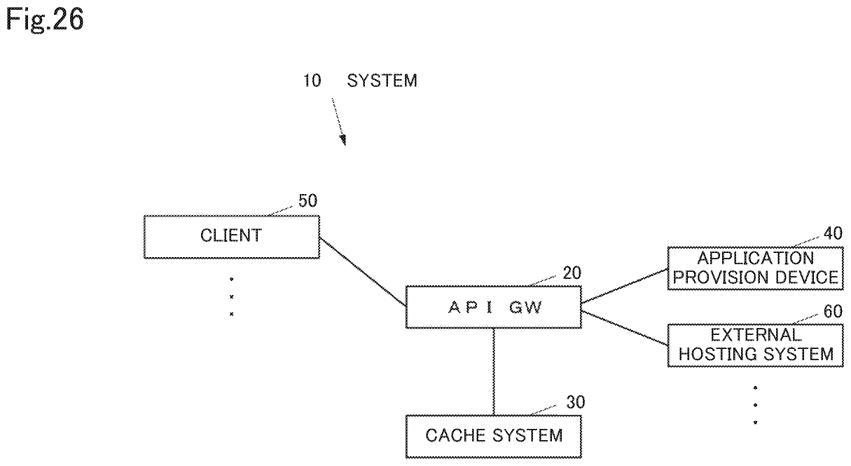

FIG. 26 is a block diagram showing an example of the system 10 according to the third embodiment of the disclosure. In the third embodiment, the system 10 further includes an external hosting system 60, in addition to the API GW 20, the cache system 30, the application provision device 40, and the client 50. The external hosting system 50 is a platform that hosts applications provided outside of the application provision device 40 (hereinafter, “external application”).

The system 10 may include external hosting systems configured similarly to the external hosting system 60, in addition to the external hosting system 60. The applications provided by the external hosting system may be a Web application to be operated by a user, or a Web service that releases the API to be utilized by the Web application or the Web service. The external hosting system may be constituted of a single computer such as a PC, or a plurality of computers. The external hosting system may be provided on a cloud.

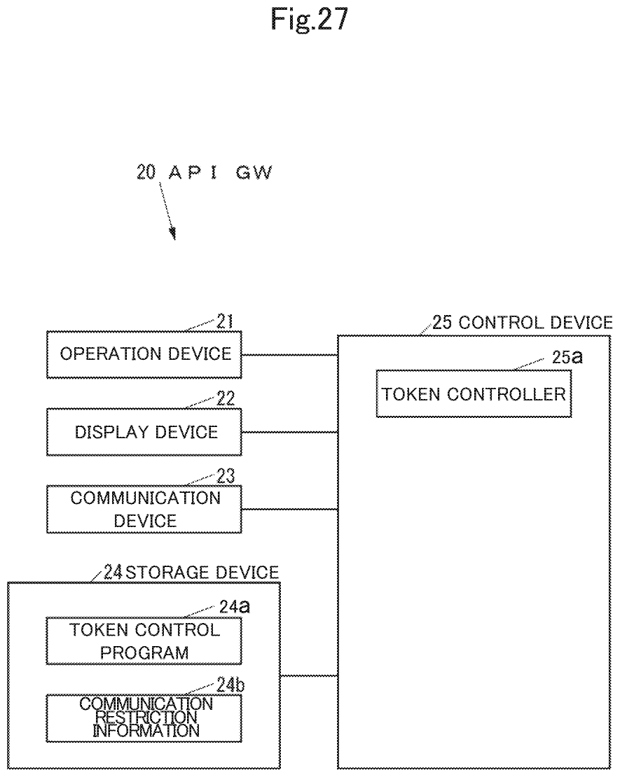

FIG. 27 is a block diagram showing an example of the API GW 20 constituted of a single computer, in the system 10 according to the third embodiment. In the API GW 20 of the system 10 according to the third embodiment, the storage device 24 stores therein information for restricting the communication with the application (hereinafter, “communication restriction information”) 24b.

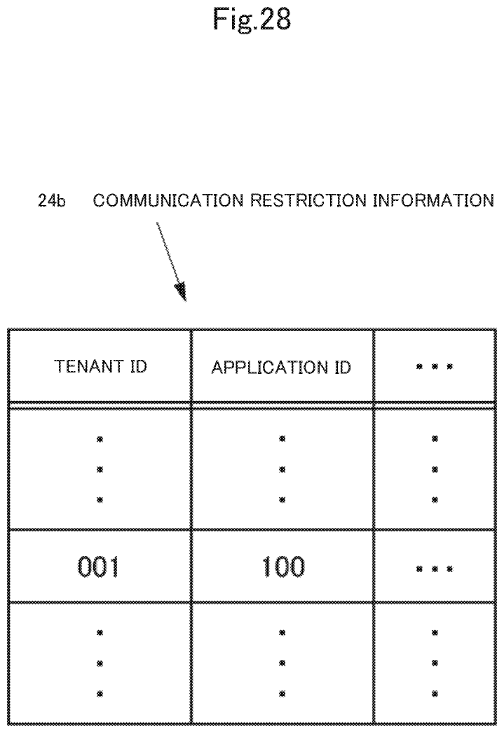

FIG. 28 is a table showing an example of the communication restriction information 24b. As shown in FIG. 28, the communication restriction information 24b includes the tenant ID serving as the identification information of the tenant, and the application ID serving as the identification information of the application, with respect to each of the applications. The communication restriction information 24b shown in FIG. 28 only shows a part of specific values.

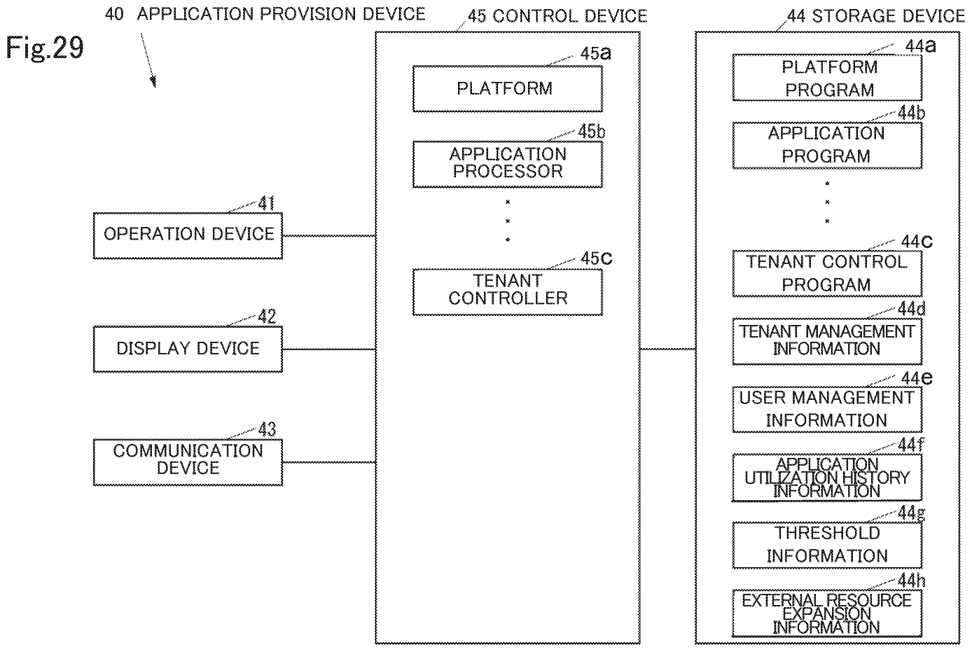

FIG. 29 is a block diagram showing an example of the application provision device 40 constituted of a single computer, in the system 10 according to the third embodiment. As shown in FIG. 29, the storage device 44 can store therein information for expanding the resource for executing an external application (hereinafter, “external resource expansion information”) 44h.

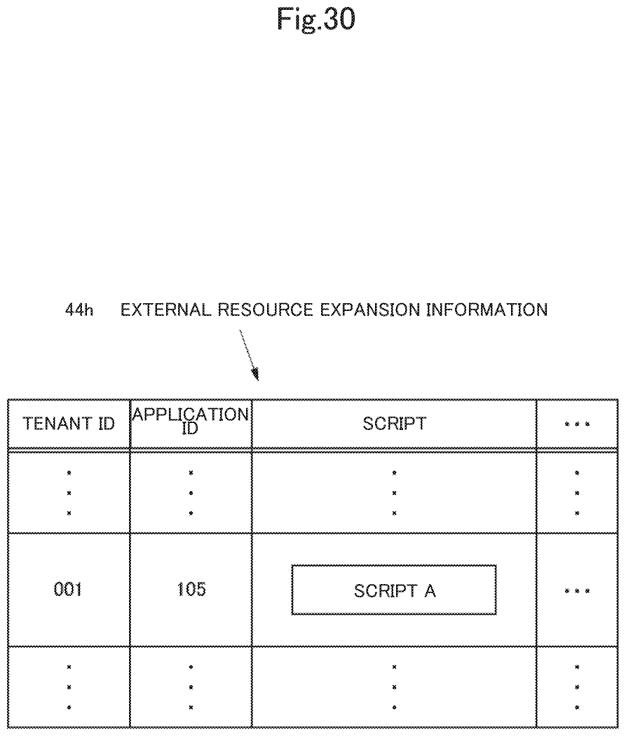

FIG. 30 is a table showing an example of the external resource expansion information 44h. As shown in FIG. 30, the external resource expansion information 44h includes the tenant ID involved with the external application, the application ID of the external application, and a script for upgrading a plan contracted by the tenant with the external application to another plan of a higher tier, with respect to each of the external applications. The external resource expansion information 44h shown in FIG. 30 only shows a part of specific values.

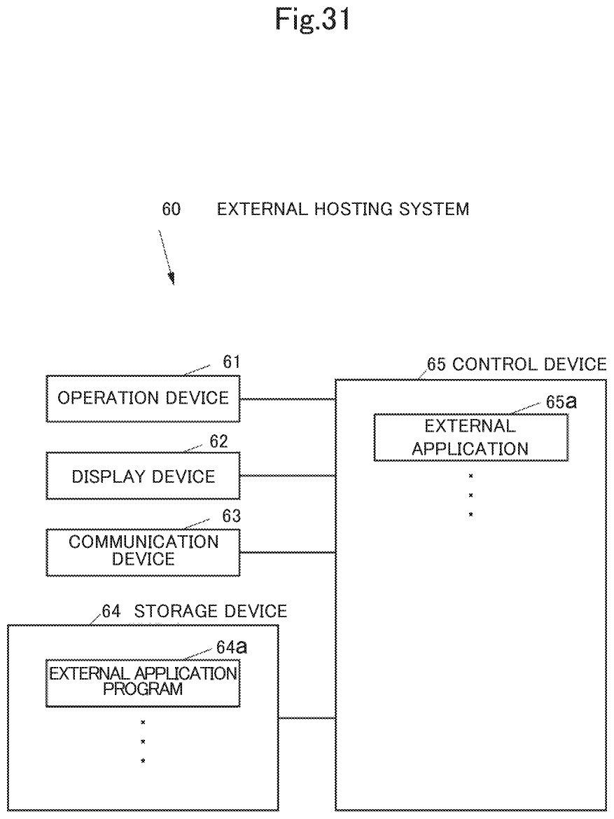

FIG. 31 is a block diagram showing an example of the external hosting system 60 constituted of a PC, in the system 10 according to the third embodiment.

As shown in FIG. 31, the external hosting system 60 includes an operation device 61 including, for example, a keyboard and a mouse for inputting various operations, a display device 62, for example including an LCD for displaying various types of information, a communication device 63 that performs communication with an external device, via a network such as a LAN or the internet, or directly through wired or wireless communication, a storage device 64 including a non-volatile memory unit such as a semiconductor memory or an HDD, for storing various types of information, and a controller 65 that controls the overall operation of the external hosting system 60.

The storage device 64 stores therein a plurality of programs for realizing the external application (hereinafter, “external application program”). For example, the storage device 64 stores therein an external application program 64a. The external application programs may be manufactured by a manufacturer different from that of the external hosting system 60. The external application program may be, for example, installed in the external hosting system 60 during the manufacturing process thereof, additionally installed in the external hosting system 60 from an external storage medium such as a USB memory, or additionally installed in the external hosting system 60 from a network.

The controller 65 includes, for example, a CPU exemplifying the processor, a ROM containing programs and various types of data, and a RAM serving as the operation region for the CPU of the controller 65. The CPU of the controller 65 executes the programs stored in the storage device 64 or the ROM of the controller 65.

The controller 65 realizes the external application, by executing the external application program. For example, the controller 65 acts as an external application processor 65a, by executing the external application program 64a. In the third embodiment, the operation of the system 10, performed when the application provided by the application provision device 40 is utilized by the client 50, is similar to that of the second embodiment.

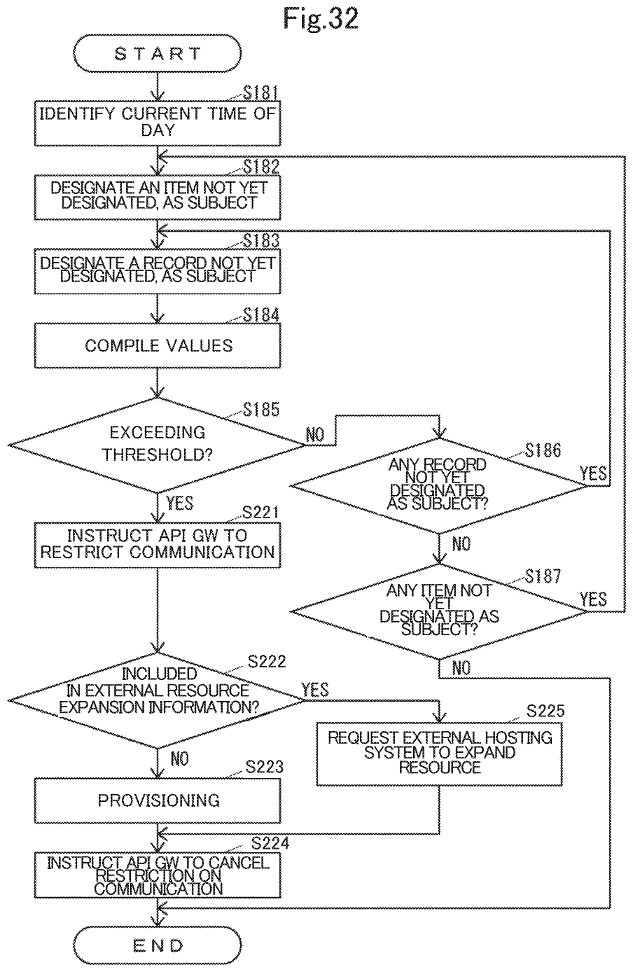

Hereunder, an operation of the tenant controller 45c according to the third embodiment, performed upon receipt of the history update notice, will be described. FIG. 32 is a flowchart showing an operation of the tenant controller 45c according to the third embodiment, performed upon receipt of the history update notice.

In the third embodiment, the tenant controller 45c instructs the API GW 20 to restrict the communication with the application identified by the combination of the tenant ID and the application ID, included in the subject history update notice, upon deciding at S185 that the compiled value of S184 exceeds the threshold specified for the item which is the current subject in the record which is the current subject in the threshold information 44g (S221). Upon receipt of the instruction of S221, the token controller 25a of the API GW 20 writes the combination of the tenant ID and the application ID included in the instruction of S221, in the communication restriction information 24b.

After finishing the operation of S221, the tenant controller 45c decides whether the external resource expansion information 44h includes the combination of the tenant ID and the application ID included in the subject history update notice (S222).

Upon deciding at S222 that the external resource expansion information 44h does not include the combination of the tenant ID and the application ID included in the subject history update notice, the tenant controller 45c performs the provisioning of the resource for executing the application in the application provision device 40, identified by the combination of the tenant ID and the application ID included in the subject history update notice (S223).

Upon deciding at S222 that the external resource expansion information 44h includes the combination of the tenant ID and the application ID included in the subject history update notice, the tenant controller 45c requests the external hosting system to expand the resource required for executing the external application, by executing the script associated with the combination of the tenant ID and the application ID included in the subject history update notice, in the external resource expansion information 44h (S225).

After finishing the operation of S223 or S225, the tenant controller 45c instructs the API GW 20 to cancel the restriction on the communication with the application identified by the combination of the tenant ID and the application ID included in the subject history update notice (S224). Upon receipt of the instruction of S224, the token controller 25a of the API GW 20 deletes the combination of the tenant ID and the application ID included in the instruction of S224, from the communication restriction information 24b.

Upon deciding at S187 that there is no item not yet designated as the subject in the current operation according to FIG. 32, among the items to be updated included in the subject history update notice, or finishing the operation of S224, the tenant controller 45c finishes the operation specified in FIG. 32.

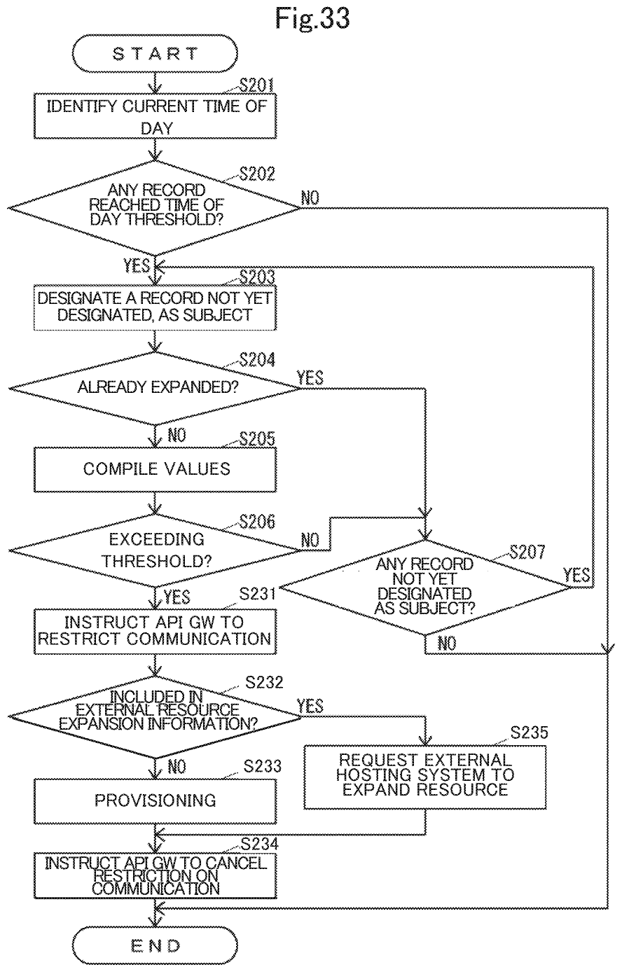

Hereunder, an operation of the tenant controller 45c according to the third embodiment, performed when periodically confirming whether to expand the execution resource of the application, will be described. FIG. 33 is a flowchart showing the operation of the tenant controller 45c, performed when periodically confirming whether to expand the execution resource of the application.

The tenant controller 45c periodically executes the operation specified in FIG. 33, for example every minute.

As shown in FIG. 33, the tenant controller 45c identifies the current time of the day (S201).

After finishing the operation of S201, the tenant controller 45c decides whether there are one or more records that reached the time of day threshold, after the time of day identified at S201 in the previous operation according to FIG. 33, and before the time of day identified at S201 in the current operation according to FIG. 33, among the records included in the threshold information 44g (S202).

Upon deciding at S202 that there are one or more records that reached the time of day threshold, after the time of day identified at S201 in the previous operation according to FIG. 33, and before the time of day identified at S201 in the current operation according to FIG. 33, among the records included in the threshold information 44g, the tenant controller 45c designates, as the subject, a record not yet designated as the subject in the current operation, among the records included in the threshold information 44g that reached the time of day threshold, after the time of day identified at S201 in the previous operation, and before the time of day identified at S201 in the current operation (S203).

After finishing the operation of S203, the tenant controller 45c decides whether the resource for executing the application, identified by the combination of the tenant ID and the application ID in the record which is the current subject in the threshold information 44g, has already been expanded in the current operation (S204).

Upon deciding at S204 that the resource for executing the application, identified by the combination of the tenant ID and the application ID in the record which is the current subject in the threshold information 44g, has not yet been expanded in the current operation, the tenant controller 45c compiles the values of the items for which the threshold is specified, in the record which is the current subject in the threshold information 44g, with respect to the history that satisfies the condition of the tenant ID, the application ID, and the API ID in the record which is the current subject in the threshold information 44g, and that includes the time of day of reception, in the period preceding from the time of day identified at S201, the time of day identified at S201 inclusive, by the period corresponding to the compilation period threshold in the record which is the current subject, among the histories included in the application utilization history information 44f (S205).

After finishing the operation of S205, the tenant controller 45c decides whether the compiled value of S205 is higher than the threshold specified for the record which is the current subject, in the threshold information 44g (S206).

Upon deciding at S204 that the resource for executing the application, identified by the combination of the tenant ID and the application ID in the record which is the current subject in the threshold information 44g, has already been expanded in the current operation, or deciding at S206 that the compiled value of S205 is not higher than the threshold specified in the record which is the current subject, in the threshold information 44g, the tenant controller 45c decides whether there are one or more records not yet designated as the subject in the current operation, among the records in the threshold information 44g that reached the time of day threshold after the time of day identified at S201 in the previous operation, and before the time of day identified at S201 in the current operation (S207).

Upon deciding at S207 that there are one or more records not yet designated as the subject in the current operation, among the records in the threshold information 44g, that reached the time of day threshold after the time of day identified at S201 in the previous operation, and before the time of day identified at S201 in the current operation, the tenant controller 45c executes the operation of S203.

Upon deciding at S206 that the compiled value of S205 is higher than the threshold specified for the record which is the current subject, in the threshold information 44g, the tenant controller 45c instructs the API GW 20 to restrict the communication with the application identified by the combination of the tenant ID and the application ID, in the record which is the current subject in the threshold information 44g (S231). Upon receipt of the instruction of S231, the token controller 25a of the API GW 20 writes the combination of the tenant ID and the application ID included in the instruction of S231, in the communication restriction information 24b.

After finishing the operation of S231, the tenant controller 45c decides whether the external resource expansion information 44h includes the combination of the tenant ID and the application ID in the record which is the current subject in the threshold information 44g (S232).

Upon deciding at S232 that the external resource expansion information 44h does not include the combination of the tenant ID and the application ID in the record which is the current subject in the threshold information 44g, the tenant controller 45c expands, by provisioning, the resource for executing the application in the application provision device 40, identified by the combination of the tenant ID and the application ID in the record which is the current subject in the threshold information 44g (S233).

Upon deciding at S232 that the external resource expansion information 44h includes the combination of the tenant ID and the application ID in the record which is the current subject in the threshold information 44g, the tenant controller 45c requests the external hosting system to expand the resource required for executing the external application, by executing the script associated with the combination of the tenant ID and the application ID in the record which is the current subject in the threshold information 44g, in the external resource expansion information 44h (S235).

After finishing the operation of S233 or S235, the tenant controller 45c instructs the API GW 20 to cancel the restriction on the communication with the application identified by the combination of the tenant ID and the application ID, in the record which is the current subject in the threshold information 44g (S234). Upon receipt of the instruction of S234, the token controller 25a of the API GW 20 deletes the combination of the tenant ID and the application ID included in the instruction of S234, from the communication restriction information 24b.

Upon deciding at S202 that there is no record that reached the time of day threshold, after the time of day identified at S201 in the previous operation, and before the time of day identified at S201 in the current operation, among the records included in the threshold information 44g, deciding at S207 that there is no record not yet designated as the subject in the current operation, among the records in the threshold information 44g that reached the time of day threshold, after the time of day identified at S201 in the previous operation, and before the time of day identified at S201 in the current operation, or finishing the operation of S234, the tenant controller 45c finishes the operation specified in FIG. 33.

As described above, when the utilization status of a specific external application by a specific tenant exceeds a specific utilization amount (YES at S185 or S206), the application provision device 40 according to the third embodiment expands the resource for this tenant to execute the external application (S225 or S235). Therefore, the execution resource can be expanded, according to the utilization status of the application.

In the case of existing application managing technique, not designed like the foregoing embodiments, the execution resource is unable to be provisioned, according to the utilization status of the application. However, the arrangement according to the foregoing embodiments enables the execution resource to be adjusted, according to the utilization status of the application.

While the present disclosure has been described in detail with reference to the embodiments thereof, it would be apparent to those skilled in the art that the various changes and modifications may be made therein within the scope defined by the appended claims.

What is claimed is:

1. An application provision device comprising:
a storage device in which a tenant control program is stored; and
a control device that includes a processor, and acts, when the processor executes the tenant control program, as a tenant controller that adjusts, when utilization status of a specific application by a specific tenant exceeds a predetermined utilization amount, a resource for the specific tenant to execute the specific application.

2. The application provision device according to claim 1,
wherein the tenant controller performs provisioning of the resource for the specific tenant to execute the specific application, as management of the resource.

3. The application provision device according to claim 2,
wherein the utilization status includes a number of times that the specific application has invoked an API.

4. The application provision device according to claim 2,
wherein the utilization status includes a data transfer amount between an API gateway that transfers an application utilization instruction, for instructing to utilize the specific application, to the specific application, and the specific application.

5. The application provision device according to claim 2,
wherein the utilization status includes a communication duration time between the API gateway and the specific application, after an API gateway that transfers an application utilization instruction, for instructing to utilize the specific application, to the specific application, received the application utilization instruction, and until the API gateway receives a response from the specific application.

6. The application provision device according to claim 2,
wherein the tenant controller decides whether the utilization status exceeds the predetermined utilization amount, each time the utilization status changes.

7. The application provision device according to claim 2,
wherein the tenant controller periodically decides whether the utilization status exceeds the predetermined utilization amount.

8. The application provision device according to claim 2,
wherein, when the utilization status of the specific application by the specific tenant exceeds a specific utilization status, the tenant controller performs the provisioning of the resource for the specific tenant to execute the specific application, as management of the resource, after restricting communication between the specific tenant and the specific application.

9. The application provision device according to claim 8,
wherein the tenant controller cancels the restriction on the communication, after the provisioning of the resource, with the communication being restricted.

10. The application provision device according to claim 1,
wherein, when the utilization status by the specific tenant, of an external application, which is an application provided outside of the application provision device, exceeds a specific utilization status, the tenant controller expands the resource for the specific tenant to execute the external application, as management of the resource.

11. A computer-readable, non-transitory recording medium having an application provision program recorded thereon,
wherein the application provision program causes the computer to act as a tenant controller that adjusts, when utilization status of a specific application by a specific tenant exceeds a predetermined utilization amount, a resource for the specific tenant to execute the specific application.

12. The computer-readable, non-transitory recording medium having the application provision program recorded thereon, according to claim 11,
wherein the application provision program further causes the computer to cause the tenant controller to perform provisioning of the resource for the specific tenant to execute the specific application, as management of the resource.

13. The computer-readable, non-transitory recording medium having the application provision program recorded thereon, according to claim 12,
wherein the application provision program further causes the computer to cause the tenant controller, when the utilization status of the specific application by the specific tenant exceeds a specific utilization status, to perform the provisioning of the resource for the specific tenant to execute the specific application, as management of the resource, after restricting communication between the specific tenant and the specific application.

14. The computer-readable, non-transitory recording medium having the application provision program recorded thereon, according to claim 11,
wherein the application provision program further causes the computer to cause the tenant controller, when the utilization status by the specific tenant, of an external application, which is an application provided outside of the application provision device, exceeds a specific utilization status, to expand the resource for the specific tenant to execute the specific application, as management of the resource.
